(19) United States
(12) Patent Application Publication
(10) Pub. No.: US 2026/0057118 A1
(43) Pub. Date: Feb. 26, 2026

(54) MEMORY SYSTEM AND INFORMATION PROCESSING SYSTEM

(71) Applicant: Kioxia Corporation, Tokyo (JP)

(72) Inventor: Hirotomo KOBAYASHI, Yokosuka (JP)

(73) Assignee: Kioxia Corporation, Tokyo (JP)

(21) Appl. No.: 19/059,426

(22) Filed: Feb. 21, 2025

(30) Foreign Application Priority Data
Aug. 20, 2024 (JP) 2024-138479

(51) Int. Cl. G06F 21/79; G06F 21/60

(52) U.S. Cl. CPC G06F 21/79; G06F 21/602; G06F 21/606

(57) ABSTRACT

According to one embodiment, a memory system is used by a first user that belongs to a group, and includes a controller. The controller manages a first key pair that includes a first private key and a first public key and stores, in a nonvolatile memory, one or more pieces of content information that include one or more contents, respectively. When use of a first content among the one or more contents by the first user has been requested, the controller generates a first access log related to the use, generates first signature data for the first access log by using the first private key, stores the first access log and the first signature data in the nonvolatile memory, and transmits the first access log and the first signature data to the one or more other memory systems.

### CROSS-REFERENCE TO RELATED APPLICATIONS

This application is based upon and claims the benefit of priority from Japanese Patent Application No. 2024-138479, filed Aug. 20, 2024, the entire contents of which are incorporated herein by reference.

### FIELD

Embodiments described herein relate generally to a memory system that includes a nonvolatile memory, and an information processing system.

### BACKGROUND

In recent years, memory systems that include a nonvolatile memory have been widely used. As one of such memory systems, a solid state drive (SSD) that includes a NAND flash memory is known. The SSD is used as a main storage of various computing devices.

A plurality of members that belong to a group may share and use a digital content (hereinafter, also simply referred to as a content).

As a method of managing such a content, for example, there is a method of centrally managing the content by a server. In this method, the content is stored, for example, in a memory system included in or connected to the server. The members can use the managed content by accessing the server. However, in this method, for example, purchase of the server, construction of an access management system on the server, and operation of the access management system are required, which result in a high introduction cost.

As another management method not using the server, there is a method of storing the content in a storage medium such as a digital versatile disc (DVD™) or an SD™ memory card to share the content. Such a storage medium has a smaller storage capacity than the memory system (for example, the SSD). Therefore, a plurality of storage media are used to share the content. Furthermore, it is necessary to manage lending the shared content to a member by associating the content with the storage media in which the content is stored. As a management method therefor, when the content (that is, the storage media in which the content is stored) is lent out, the member borrowing the content often voluntarily writes (enters) his/her name on a lending list. In managing lending through the voluntary writing, it can become unclear which member currently has the content borrowed. As a result, there is a risk that the content (storage media) is lost or leaked to a third party.

### BRIEF DESCRIPTION OF THE DRAWINGS

FIG. 1 is a block diagram illustrating a configuration example of an information processing system that includes a memory system according to an embodiment.

FIG. 2 is a block diagram illustrating a configuration example of the memory system according to the embodiment.

FIG. 3 is a diagram illustrating a configuration example of a group public key management table that is used in the memory system according to the embodiment.

FIG. 4 is a diagram illustrating a configuration example of a content information management table that is used in the memory system according to the embodiment.

FIG. 5 is a diagram illustrating a configuration example of a content use log management table that is used in the memory system according to the embodiment.

FIG. 6 is a diagram illustrating an example of a public key registration operation in the information processing system that includes the memory system according to the embodiment.

FIG. 7 is a diagram illustrating an example of a public key exchange and registration operation in the memory system according to the embodiment in a case where public keys are exchanged with another memory system.

FIG. 8 is a diagram illustrating an example of a public key verification and registration operation in the memory system according to the embodiment in a case where public key information is received from each of other memory systems.

FIG. 9 is a diagram illustrating an example of a content registration operation in the information processing system that includes the memory system according to the embodiment.

FIG. 10 is a diagram illustrating an example of a content registration and transmission operation in the memory system according to the embodiment in a case where content information is received from a host.

FIG. 11 is a diagram illustrating an example of a content reception and registration operation in the memory system according to the embodiment in a case where the content information is received from another memory system.

FIG. 12 is a diagram illustrating an example of a use start information logging operation in the information processing system that includes the memory system according to the embodiment.

FIG. 13 is a diagram illustrating an example of a use control and start information logging operation in the memory system according to the embodiment in a case where use of a content is requested.

FIG. 14 is a diagram illustrating an example of a start information reception and logging operation in the memory system according to the embodiment in a case where use start information indicative of use start of a content is received from another memory system.

FIG. 15 is a diagram illustrating an example of a use completion information logging operation in the information processing system that includes the memory system according to the embodiment.

FIG. 16 is a diagram illustrating an example of a completion detection and completion information logging operation in the memory system according to the embodiment in a case where use of a content has been completed.

FIG. 17 is a diagram illustrating an example of a completion information reception and logging operation in the memory system according to the embodiment in a case where use completion information indicative of use completion of a content is received from another memory system.

FIG. 18 is a flowchart illustrating an example of the procedure of a public key registration process executed in the memory system according to the embodiment.

FIG. 19 is a flowchart illustrating an example of the procedure of a public key verification and registration process executed in the memory system according to the embodiment.

FIG. 20 is a flowchart illustrating an example of the procedure of a use control and start information logging process executed in the memory system according to the embodiment.

FIG. 21 is a flowchart illustrating an example of the procedure of a completion information logging process executed in the memory system according to the embodiment.

FIG. 22 is a flowchart illustrating an example of the procedure of a use log verification and registration process executed in the memory system according to the embodiment.

### DETAILED DESCRIPTION

In general, according to one embodiment, a memory system is used by a first user that belongs to a group. The memory system includes a nonvolatile memory and a controller. The controller is electrically connected to the nonvolatile memory. The controller communicates with one or more other memory systems that are respectively used by one or more users other than the first user. The one or more users belong to the group. The controller manages a first key pair that includes a first private key and a first public key. The controller stores, in the nonvolatile memory, one or more pieces of content information that include one or more contents, respectively. When use of a first content among the one or more contents by the first user has been requested, the controller generates a first access log related to the use. The controller generates first signature data for the first access log by using the first private key. The controller stores the first access log and the first signature data in the nonvolatile memory. The controller transmits the first access log and the first signature data to the one or more other memory systems.

Various embodiments will be described hereinafter with reference to the accompanying drawings.

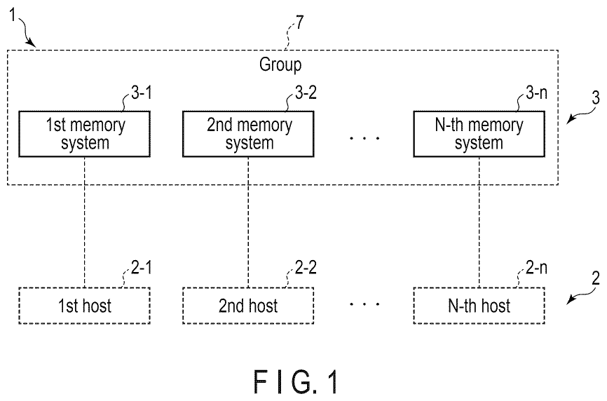

First, a configuration example of an information processing system 1 that includes a memory system according to an embodiment will be described with reference to FIG. 1. The information processing system 1 is a system for a plurality of users that belong to a group 7 to share and use at least one digital content (content). The information processing system 1 manages using (for example, viewing or reading) of the shared content. The group 7 is, for example, a small community. The user belonging to the group 7 is also referred to as a member or a group member. The content is various types of data desired to be shared among the members. Examples of the content include video data created by a member, data of an electronic book purchased by a member, or data of minutes, voice data, and video data that are related to a meeting held by members.

The information processing system 1 includes a plurality of memory systems 3. The plurality of memory systems 3 are, for example, memory systems that are respectively used by a plurality of members. The plurality of memory systems 3 are, for example, n memory systems 3-1, 3-2, . . . , and 3-n. Note that n is an integer of two or more. The n memory systems 3-1, 3-2, . . . , and 3-n are referred to as a first memory system 3-1, a second memory system 3-2, . . . , and an n-th memory system 3-n, respectively. One memory system that is not specified among the n memory systems 3-1, 3-2, . . . , and 3-n is also referred to as a memory system 3.

The information processing system 1 may further include a plurality of host devices 2 (hereinafter, referred to as hosts 2). The plurality of hosts 2 are terminals that correspond to the plurality of memory systems 3, respectively. The plurality of hosts 2 are, for example, n hosts 2-1, 2-2, . . . , and 2-n. The n hosts 2-1, 2-2, . . . , and 2-n are referred to as a first host 2-1, a second host 2-2, . . . , and an n-th host 2-n, respectively. One host that is not specified among the n hosts 2-1, 2-2, . . . and 2-n is also referred to as a host 2.

The host 2 may use the corresponding memory system 3 as a storage. The host 2 may be connected to the corresponding memory system 3 via a cable or a network, or the corresponding memory system 3 may be provided inside the host 2. The host 2 includes an input device for the user to perform an operation of inputting information (data). The input device is, for example, a keyboard and a pointing device such as a mouse or a touch screen display.

The memory system 3 is a storage device configured to write data into a nonvolatile memory and read data from the nonvolatile memory. The nonvolatile memory is, for example, a NAND flash memory. The memory system 3 is also referred to as a storage device or a semiconductor storage device. The memory system 3 is implemented as, for example, a solid state drive (SSD) that includes a NAND flash memory or a hard disk drive (HDD). Hereinafter, a case where the memory system 3 is an SSD will be mainly explained.

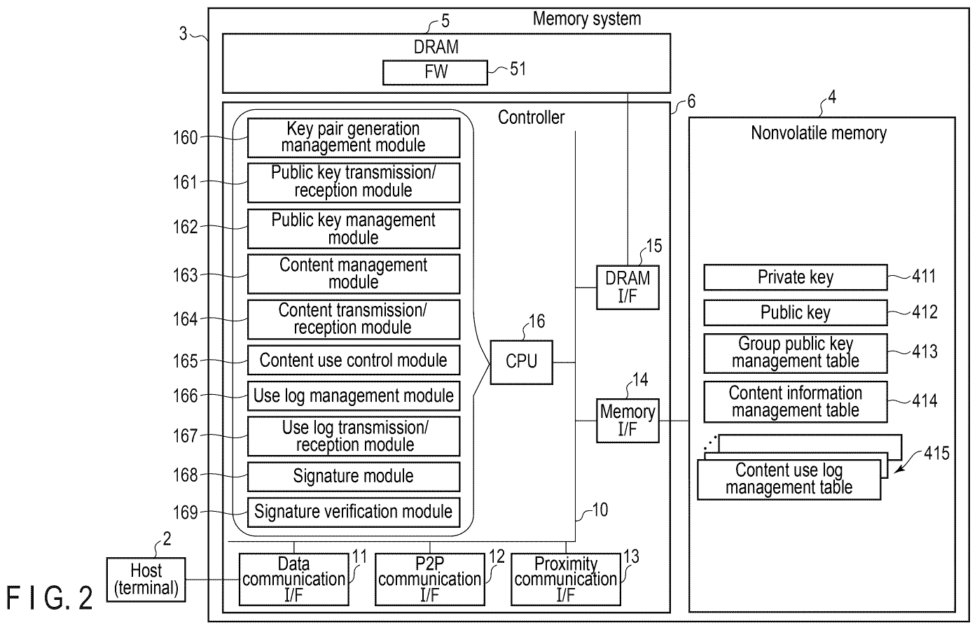

FIG. 2 is a block diagram illustrating a configuration example of the memory system 3.

The memory system 3 includes, for example, a nonvolatile memory 4 and a controller 6. The memory system 3 may further include a dynamic random access memory (DRAM) 5.

The nonvolatile memory 4 includes a plurality of blocks. The plurality of blocks each function as a minimum unit of a data erase operation. The block is also referred to as an erase block or a physical block. Each of the plurality of blocks includes a plurality of pages. Each of the plurality of pages includes a plurality of memory cells connected to a single word line. The plurality of pages each function as a unit of a data write operation and a data read operation. Note that a word line may also function as a unit of a data write operation and a data read operation.

The tolerable maximum number of program/erase cycles (maximum number of P/E cycles) for each of the blocks is limited. One P/E cycle of a block includes a data erase operation to erase data stored in all memory cells of the block and a data program operation to write data in each page of the block.

The nonvolatile memory 4 stores, for example, a private key 411, a public key 412, a group public key management table 413, a content information management table 414, and one or more content use log management tables 415.

The private key 411 and the public key 412 are a key pair corresponding to a member who uses the memory system 3. The private key 411 is used for encryption of data and decryption of data encrypted with the public key 412. It is assumed that the private key 411 cannot be read from the outside of the memory system 3 and does not leak to the outside. The public key 412 is used for encryption of data and decryption of data encrypted with the private key 411.

The group public key management table 413 is data for managing a public key 412 corresponding to each member that belongs to the group 7. The group public key management table 413 may be temporarily read from the nonvolatile memory 4 to the DRAM 5 (that is, the group public key management table 413 may be cached in the DRAM 5).

The content information management table 414 is data for managing one or more contents that are stored in the nonvolatile memory 4. The one or more contents are contents that may be used by the members belonging to the group 7. The content information management table 414 may be temporarily read from the nonvolatile memory 4 to the DRAM 5.

The one or more content use log management tables 415 are associated with the one or more contents stored in the nonvolatile memory 4, respectively. Each of the one or more content use log management tables 415 is data for managing use of a corresponding content. One content use log management table 415 is generated, for example, when one content has been stored in the nonvolatile memory 4. The content use log management tables 415 may be temporarily read from the nonvolatile memory 4 to the DRAM 5.

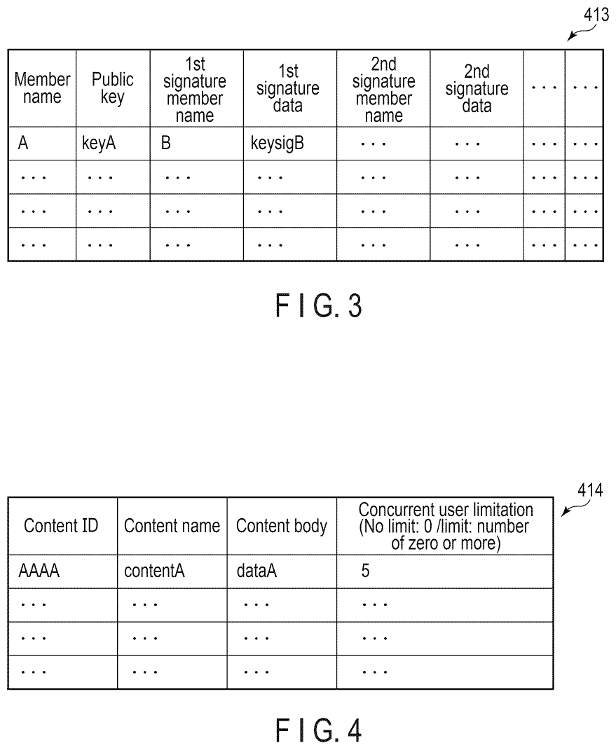

With reference to FIGS. 3 to 5, the group public key management table 413, the content information management table 414, and the one or more content use log management tables 415 will be described.

### Group Public Key Management Table 413

FIG. 3 illustrates a configuration example of the group public key management table 413. The group public key management table 413 includes, for example, a plurality of entries that correspond to the plurality of members, respectively. Each of the plurality of entries includes a member name field, a public key field, and a signature member name field, and a signature data field.

The member name field indicates a name of a corresponding member (member name). The member name is information by which the corresponding member is uniquely identifiable. For example, a character string that represents the member name is set in the member name field.

The public key field indicates a public key 412 of the corresponding member. The public key 412 of the member is a public key that is generated and managed in a memory system 3 used by the member. For example, the public key 412 in a privacy-enhanced mail (PEM) format is set in the public key field.

The signature member name field and the signature data field are paired fields.

The signature member name field indicates a name of a member who has created signature data for the public key 412 set in the public key field. More specifically, the member who has created the signature data is a member using a memory system 3 in which the signature data has been generated. For example, a character string representing the name of the member who has created the signature data is set in the signature member name field.

The signature data field indicates signature data for the public key 412 set in the public key field. The signature data is signature data generated in the memory system 3 used by the member indicated in the signature member name field.

Note that each entry may include a plurality of pairs of the signature member name field and the signature data field. Specifically, each entry includes a plurality of pairs such as a pair of a first signature member name field and a first signature data field, and a pair of a second signature member name field and a second signature data field. The number of pairs of the signature member name field and the signature data field included in each entry can be freely set on the basis of, for example, the number of members that belong to the group 7.

In the example illustrated in FIG. 3, signature data “keysigB” of a member “B” is associated with a public key “keyA” of a member “A”. This means that the authenticity of the public key “keyA” of the member “A” is ensured by the signature data “keysigB” of the member “B”.

With the configuration of the group public key management table 413 described above, the memory system 3 can securely manage the public key 412 corresponding to each member.

### Content Information Management Table 414

FIG. 4 illustrates a configuration example of the content information management table 414. The content information management table 414 includes one or more entries that correspond to one or more contents, respectively. Each of the one or more entries includes, for example, a content ID field, a content name field, a content body field, and a concurrent user limitation field.

The content ID field indicates information by which a corresponding content is uniquely identifiable (hereinafter, a content ID). For example, a universally unique identifier (UUID) is used as the content ID.

The content name field indicates a name of the corresponding content (hereinafter, referred to as a content name). The content name is, for example, a character string given by a user who provides (for example, creates) the content.

The content body field indicates data of the corresponding content itself. For example, in a case where the content is video data, the video data is stored in the content body field.

The concurrent user limitation field indicates information of a limitation on the number of members who can use the corresponding content concurrently (in parallel). Specifically, the concurrent user limitation field indicates whether or not there is a limitation on the number of members who can concurrently use the corresponding content, and in a case where there is a limitation on the number of members who can concurrently use the corresponding content, the concurrent user limitation field indicates the number of members. In a case where there is no limitation on the number of members who can concurrently use the content, for example, 0 is set in the concurrent user limitation field. In a case where there is a limitation on the number of members who can concurrently use the content, for example, a numerical value indicative of the number of members is set in the concurrent user limitation field.

Note that the content information management table 414 may further include a field indicative of a condition under which the corresponding content is available (hereinafter, referred to as a use condition), instead of the concurrent user limitation field or in addition to the concurrent user limitation field.

In the example illustrated in FIG. 4, for a content “dataA” that has a content ID of “AAAA” and a content name of “contentA”, a concurrent user limitation is set to five.

With the above configuration of the content information management table 414, the memory system 3 can manage information for the members to use the contents.

### Content Use Log Management Table 415

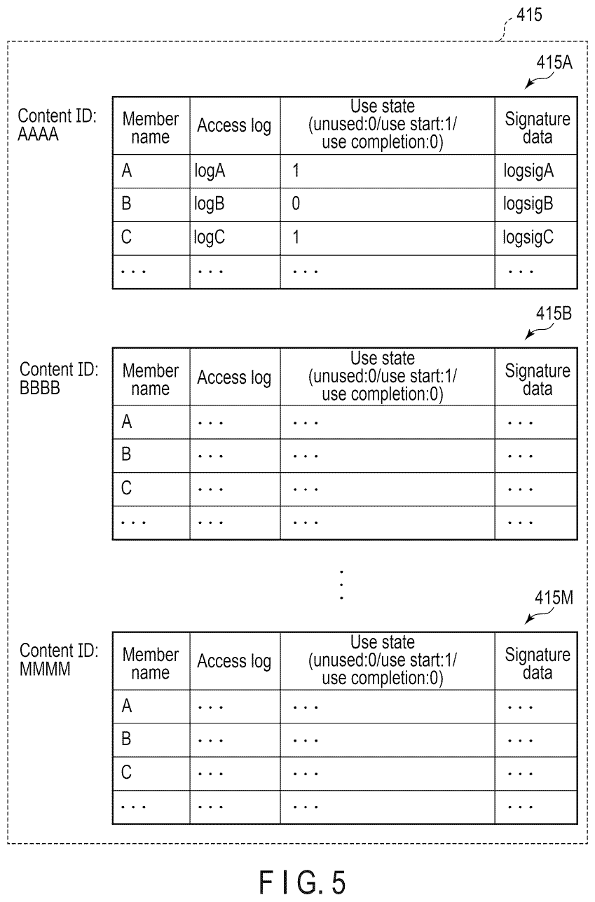

FIG. 5 illustrates a configuration example of the one or more content use log management tables 415. The one or more content use log management tables 415 are associated with the one or more contents, respectively. For example, the one or more content use log management tables 415 include content use log management tables 415A, 415B, . . . , and 415M. The content use log management table 415A is associated with a content whose content ID is “AAAA”. The content use log management table 415B is associated with a content whose content ID is “BBBB”. The content use log management table 415M is associated with a content whose content ID is “MMMM”.

Each of the one or more content use log management tables 415 includes a plurality of entries corresponding to the plurality of members, respectively. Each of the plurality of entries includes, for example, a member name field, an access log field, a use state field, and a signature data field.

Here, each field will be described by taking, as an example, the content use log management table 415A associated with the content whose content ID is “AAAA” (hereinafter, referred to as a content A).

The member name field indicates a name of a corresponding member (member name).

The access log field indicates log data (that is, an access log) related to use of the content A by the corresponding member. The access log includes, for example, information indicative of an access date and time, the member name, and the content ID. Specifically, for example, in an access to the content A by the member “A”, the access date and time indicates, for example, a date and time when the member “A” has started or completed the use of the content A. The member name indicates the member “A”. The content ID indicates the content ID “AAAA”. The access log may further include other information on the use of the content A.

The use state field indicates a use state of the content A by the corresponding member. For example, one of a value (information) indicative of unused or use completion and a value indicative of use start is set in the use state field.

Unused means that the corresponding member has not used the content A yet. Use completion means that the corresponding member has completed (finished) the use of the content A. In other words, unused and use completion mean that the corresponding member is not currently using the content A. For example, “0” is set in the use state field as a value indicative of unused or use completion. Any information indicative of unused or use completion, which is not limited to “0”, may be set in the use state field.

Use start means that the corresponding member has started the use of the content A. In other words, use start means that the corresponding member is currently using the content A. For example, “1” is set in the use state field as a value indicative of use start. Any information indicative of use start, which is not limited to “1”, may be set in the use state field.

Therefore, the number of members currently using the content A is obtained by counting the total number of entries in which “1” are set in the use state fields, in the content use log management table 415A.

The signature data field indicates signature data for the access log set in the access log field. The signature data is used to verify the authenticity of the access log. Specifically, the authenticity of the access log can be verified by using the signature data and the public key 412 of the corresponding member.

In the example of the content use log management table 415A illustrated in FIG. 5, a state in which the member “A” is using the content A (use state “1”) is indicated, and an access log “log A” related to the use of the content A by the member “A” and signature data “log sigA” for the access log “log A” are managed. In addition, a state in which the member “B” is not using the content A (use state “0”) is indicated, and an access log “log B” related to the use of the content A by the member “B” and signature data “log sigB” for the access log “log B” are managed. Furthermore, a state in which a member “C” is using the content A (use state “1”) is indicated, and an access log “log C” related to the use of the content A by the member “C” and signature data “log sigC” for the access log “log C” are managed. In this case, the number of members currently using the content A is two.

With the configuration of the content use log management table 415A, the memory system 3 can securely manage the use state of the content A by each member belonging to the group 7. Note that each of the content use log management tables 415B, . . . , and 415M has a configuration similar to that of the content use log management table 415A described above. Therefore, the memory system 3 can securely manage a use state of each of the one or more contents by each member belonging to the group 7.

The description returns to FIG. 2.

The DRAM 5 is a volatile memory. The DRAM 5 includes, for example, a storage area of firmware (FW) 51.

The FW 51 is a program for controlling an operation of the controller 6. The FW 51 is loaded from the nonvolatile memory 4 to the DRAM 5, for example.

The controller 6 may be implemented by a circuit such as a system-on-a-chip (SoC). The controller 6 is configured to control the nonvolatile memory 4. A function of each component of the controller 6 may be implemented by dedicated hardware in the controller 6 or may be implemented by a processor (for example, a central processing unit (CPU) 16) executing the FW 51.

The controller 6 may function as a flash translation layer (FTL) configured to execute data management and block management of the nonvolatile memory 4. The data management executed by the FTL includes (1) management of mapping information indicative of a relationship between each logical address and each physical address of the nonvolatile memory 4, and (2) a process to hide a difference between data read/write operations in units of page and data erase operations in units of block. The block management includes management of defective blocks, wear leveling, and garbage collection.

The logical address is used by the host 2 for addressing a storage area of the memory system 3. The logical address is, for example, a logical block address (LBA).

The management of mapping between each logical address and each physical address is executed by using, for example, a logical-to-physical address translation table. The controller 6 uses the logical-to-physical address translation table to manage the mapping between each logical address and each physical address in a certain management size. A physical address corresponding to a logical address indicates a physical memory location in the nonvolatile memory 4 to which data of the logical address is written. The controller 6 manages, by using the logical-to-physical address translation table, a plurality of storage areas that are obtained by logically dividing a storage area of the nonvolatile memory 4. The plurality of storage areas correspond to a plurality of logical addresses, respectively. That is, each of the plurality of storage areas is identified by one logical address. The logical-to-physical address translation table may be loaded from the nonvolatile memory 4 to the DRAM 5 when the memory system 3 is boot up.

The data write operation into one page is executable only once in a single P/E cycle. Thus, the controller 6 writes updated data corresponding to a logical address not to an original physical memory location in which previous data corresponding to the logical address is stored but to a different physical memory location. Then, the controller 6 updates the logical-to-physical address translation table to associate the logical address with this different physical memory location rather than the original physical memory location and to invalidate the previous data (i.e., data stored in the original physical memory location). Data to which the logical-to-physical address translation table refers (that is, data associated with a logical address) is referred to as valid data. Furthermore, data not associated with any logical address is referred to as invalid data. The valid data is data to be possibly read by the host 2 later. The invalid data is data not to be read by the host 2 anymore.

The controller 6 may include, for example, a data communication interface circuit (data communication I/F) 11, a peer-to-peer communication interface circuit (P2P communication I/F) 12, a proximity communication interface circuit (proximity communication I/F) 13, a memory interface circuit (memory I/F) 14, a DRAM interface circuit (DRAM I/F) 15, and the CPU 16. The data communication I/F 11, the P2P communication I/F 12, the proximity communication I/F 13, the memory I/F 14, the DRAM I/F 15, and the CPU 16 may be connected via a bus 10.

The data communication I/F 11 functions as a circuit (or circuitry) that performs data communication with the outside (for example, the host 2). Specifically, the data communication I/F 11 functions as a circuit that receives various commands and data from the outside. The commands include, for example, an input/output (I/O) command and a control command. The I/O command is, for example, a read command or a write command. The control command is, for example, a flush command. In addition, the data communication I/F 11 functions as a circuit that transmits a response to a command and data to the outside. In the case of functioning as a circuit that performs communication with the host 2, the data communication I/F 11 is also referred to as a host interface circuit (host I/F). The interface circuit for connecting the memory system 3 and the host 2 conforms to standards such as PCI Express™ (PCIe™), Ethernet™, Fibre channel, and NVM Express™ (NVMe™). Note that in a case where the memory system 3 is provided inside the host 2, the data communication I/F 11 may function as a circuit that performs communication with any component of the host 2.

The P2P communication I/F 12 functions as a circuit that performs P2P communication with the outside (for example, another memory system 3). The P2P communication is, for example, communication in which data is directly exchanged between two devices without passing through a server. Specifically, for example, the P2P communication I/F 12 establishes a P2P connection between the memory system 3 and another memory system 3 without passing through the server. The P2P communication I/F 12 functions as a circuit configured to transmit and receive data to and from the other memory system 3 on the established P2P connection. The P2P communication I/F 12 conforms to standards such as Ethernet and Transmission Control Protocol/Internet Protocol (TCP/IP). In this case, the P2P communication I/F 12 performs the P2P communication by using, for example, an IP address assigned to each memory system 3. In a case where the memory system 3 is provided inside the host 2, the P2P communication I/F 12 may perform the P2P communication by using an IP address assigned to the host 2.

The proximity communication I/F 13 functions as a circuit that performs proximity communication with the outside (for example, another memory system 3). The proximity communication is communication for exchanging data between two adjacent devices. That is, two devices that perform the proximity communication are within a range (distance) in which the proximity communication is executable. The proximity communication is, for example, Bluetooth™ communication. In this case, the proximity communication I/F 13 conforms to a Bluetooth standard. Specifically, the proximity communication I/F 13 establishes, for example, a Bluetooth connection between the memory system 3 and another memory system 3. The proximity communication I/F 13 functions as a circuit configured to transmit and receive data to and from the other memory system 3 on the established Bluetooth connection.

Note that in a case where the memory system 3 is provided inside the host 2, at least one of the P2P communication I/F 12 and the proximity communication I/F 13 may be provided as a component of the host 2 (that is, a component outside the memory system 3). In this case, the memory system 3 may communicate with the outside via the P2P communication I/F 12 or the proximity communication I/F 13 included in the host 2.

The memory I/F 14 electrically connects the controller 6 and the nonvolatile memory 4. The memory I/F 14 supports an interface standard such as a Toggle Double Data Rate (DDR) or an Open NAND Flash Interface (ONFI).

The memory I/F 14 functions as a memory control circuit configured to control the nonvolatile memory 4. The memory I/F 14 may be connected to a plurality of nonvolatile memory chips in the nonvolatile memory 4 via a plurality of channels, respectively. By operating the nonvolatile memory chips in parallel, it is possible to broaden an access bandwidth between the controller 6 and the nonvolatile memory 4.

The DRAM I/F 15 functions as a DRAM control circuit configured to control access to the DRAM 5.

The CPU 16 is a processor configured to control the data communication I/F 11, the P2P communication I/F 12, the proximity communication I/F 13, the memory I/F 14, and the DRAM I/F 15. The CPU 16 executes various processes by executing the FW 51 loaded from the nonvolatile memory 4 to the DRAM 5. The FW 51 is a control program including instructions for causing the CPU 16 to execute the various processes. The CPU 16 may perform command processes to execute various commands from the host 2. The operation of the CPU 16 is controlled by the FW 51 executed by the CPU 16.

The CPU 16 functions as, for example, a key pair generation management module 160, a public key transmission/reception module 161, a public key management module 162, a content management module 163, a content transmission/reception module 164, a content use control module 165, a use log management module 166, a use log transmission/reception module 167, a signature module 168, and a signature verification module 169. The CPU 16 functions as these modules, for example, by executing the FW 51.

The key pair generation management module 160 generates a key pair corresponding to the member using the memory system 3 (hereinafter, referred to as a first target member) and manages the generated key pair. The generated key pair is a pair of a private key 411 and a public key 412. For example, the key pair generation management module 160 generates the key pair when the first target member has input a member name and information on the group 7 to which the first target member belongs via the host 2. The input member name is a name of the first target member. The input information on the group 7 is information by which the group 7 to which the first target member belongs is uniquely identifiable. The key pair generation management module 160 stores the generated key pair in, for example, the nonvolatile memory 4.

The public key transmission/reception module 161 is configured to transmit information on the public key 412 of the first target member to another memory system 3 and receive information on a public key 412 of another member belonging to the group 7 from another memory system 3. Specifically, the public key transmission/reception module 161 transmits the information on the public key 412 of the first target member to another memory system 3 via the proximity communication I/F 13 or the P2P communication I/F 12. Furthermore, the public key transmission/reception module 161 receives the information on the public key 412 of another member from another memory system 3 via the proximity communication I/F 13 or the P2P communication I/F 12.

The public key management module 162 manages a public key 412 of each member by using the group public key management table 413. Specifically, the public key management module 162 registers (stores) information on a public key 412 of another member in the group public key management table 413. That is, the public key management module 162 adds an entry that includes the information on the public key 412 of the other member, to the group public key management table 413. Alternatively, the public key management module 162 updates an entry in the group public key management table 413 that corresponds to the other member by using at least a part of the information on the public key 412 of the other member. Note that the public key management module 162 may register the information on the public key 412 of the first target member in the group public key management table 413.

The content management module 163 manages one or more contents by using the content information management table 414. Specifically, for example, the content management module 163 receives, from the host 2 via the data communication I/F 11, information on a content (hereinafter, referred to as content information) input in accordance with an operation by the first target member. Alternatively, the content management module 163 may receive the content information from the content transmission/reception module 164. The content information includes, for example, a content ID, a content name, a content (that is, a content body), and a use condition. The content management module 163 registers (stores) the received content information in the content information management table 414. Note that the content management module 163 sends, to the content transmission/reception module 164, the content information received from the host 2 via the data communication I/F 11 and registered in the content information management table 414.

The content transmission/reception module 164 is configured to transmit content information to another memory system 3 and receive content information from another memory system 3. Specifically, the content transmission/reception module 164 transmits content information, which has been received from the content management module 163, to another memory system 3 via the P2P communication I/F 12. As a result, the content information is registered in the content information management table 414 in the other memory system 3. In addition, the content transmission/reception module 164 sends, to the content management module 163, content information received from another memory system 3 via the P2P communication I/F 12. The sent content information is registered in the content information management table 414 by the content management module 163.

The content use control module 165 controls use of each content by the first target member. Specifically, in a case where use of a content (hereinafter, referred to as a target content) by the first target member is requested by the host 2, the content use control module 165 controls the use of the target content by using the content information management table 414. In a case where a use condition for the target content is satisfied, the content use control module 165 transmits the target content to the host 2 via the data communication I/F 11, and generates an access log related to the use of the target content by the first target member. As a result, the first target member can use the target content. On the other hand, in a case where the use condition for the target content is not satisfied, the content use control module 165 notifies the host 2 that the target content is unavailable via the data communication I/F 11. Therefore, the first target member cannot use the target content.

In addition, the content use control module 165 detects that the use of the target content by the first target member has been completed (finished). For example, the content use control module 165 determines that the use of the content has been completed when a threshold time has elapsed after the start of the use of the target content. The threshold time is obtained by adding a certain time to a time required for playing the whole target content. For example, in a case where the time required for playing the whole target content is one hour and the certain time is one hour, the threshold time is two hours. Alternatively, the content use control module 165 may determine that the use of the target content has been completed when a period in which any request to read at least a part of data of the target content (for example, any read command) from the nonvolatile memory 4 is not received from the host 2 has exceeded a threshold (that is, timeout has occurred) after the start of the use of the target content.

The use log management module 166 manages use start and use completion of each content by each group member by using the content use log management table 415.

Specifically, the use log management module 166 stores (registers) information indicating that use of the target content by the first target member has been started (hereinafter, referred to as use start information) in the content use log management table 415 in the nonvolatile memory 4. The use start information includes, for example, an access log, a value indicative of use start, and signature data for the access log. The use log management module 166 cooperates with the signature module 168 described below to generate the signature data for the access log by using the private key 411. The use log management module 166 sends the use start information to the use log transmission/reception module 167.

In addition, the use log management module 166 stores information indicating that the use of the target content by the first target member has been completed (hereinafter, referred to as use completion information) in the content use log management table 415 in the nonvolatile memory 4. The use completion information includes, for example, an access log, a value indicative of use completion, and signature data for the access log. The use log management module 166 sends the use completion information to the use log transmission/reception module 167.

The use log transmission/reception module 167 is configured to transmit use start information or use completion information to memory systems 3 used by the one or more other group members via the P2P communication I/F 12, and receive use start information or use completion information from the memory systems 3 used by the other group members. The other group members are members belonging to the group 7 other than the first target member. Specifically, the use log transmission/reception module 167 transmits the use start information or the use completion information received from the use log management module 166 to the memory systems 3 used by the other group members. In each of the memory systems 3 that has received the use start information or the use completion information, the information may be registered in the content use log management table 415. In addition, the use log transmission/reception module 167 receives the use start information or the use completion information from the memory systems 3 used by the other group members. The use log transmission/reception module 167 sends the received use start information or use completion information to the use log management module 166.

The use log management module 166 receives the use start information or the use completion information from the use log transmission/reception module 167. When the authenticity of an access log included in the received use start information or use completion information has been confirmed, the use log management module 166 stores (registers) the use start information or the use completion information in the content use log management table 415. The use log management module 166 cooperates with the signature verification module 169 described below to acquire a verification result of the authenticity of the access log.

The signature module 168 generates signature data for specific data by using the private key 411. The specific data is, for example, a public key 412 or an access log. Specifically, the signature module 168 calculates a hash value of the specific data by using a specific hash function. The specific hash function is, for example, a hash function defined in advance in the information processing system 1. Then, the signature module 168 encrypts the calculated hash value with the private key 411, thereby generating signature data.

The signature verification module 169 verifies the authenticity of specific data by using a public key 412 (hereinafter, referred to as a verification public key 412) and signature data for the specific data. The specific data is, for example, a public key 412 other than the verification public key 412, or an access log. The verification public key 412 is a public key 412 estimated to be paired with a private key 411 that is assumed to be used for generation of the signature data. That is, the verification public key 412 is a public key 412 corresponding to a member (specifically, a memory system 3 used by the member) assumed to have generated the signature data.

Specifically, the signature verification module 169 decrypts the signature data with the verification public key 412, thereby generating a hash value. The signature verification module 169 calculates a hash value of data whose authenticity is to be verified, by using the specific hash function. In a case where these two hash values match each other, the signature verification module 169 determines that the authenticity of the data has been confirmed. The signature verification module 169 may generate (output) a verification result indicating that the authenticity of the data has been confirmed. On the other hand, in a case where these two hash values do not match each other, the signature verification module 169 determines that the authenticity of the data has not been confirmed. The signature verification module 169 may generate a verification result indicating that the authenticity of the data has not been confirmed.

With the above configuration, the memory system 3 manages use of each content by each member.

Next, the operation in the information processing system 1 will be described more specifically. The operation in the information processing system 1 includes, for example, a public key registration operation, a content registration operation, a use start information logging operation, and a use completion information logging operation.

### Public Key Registration Operation

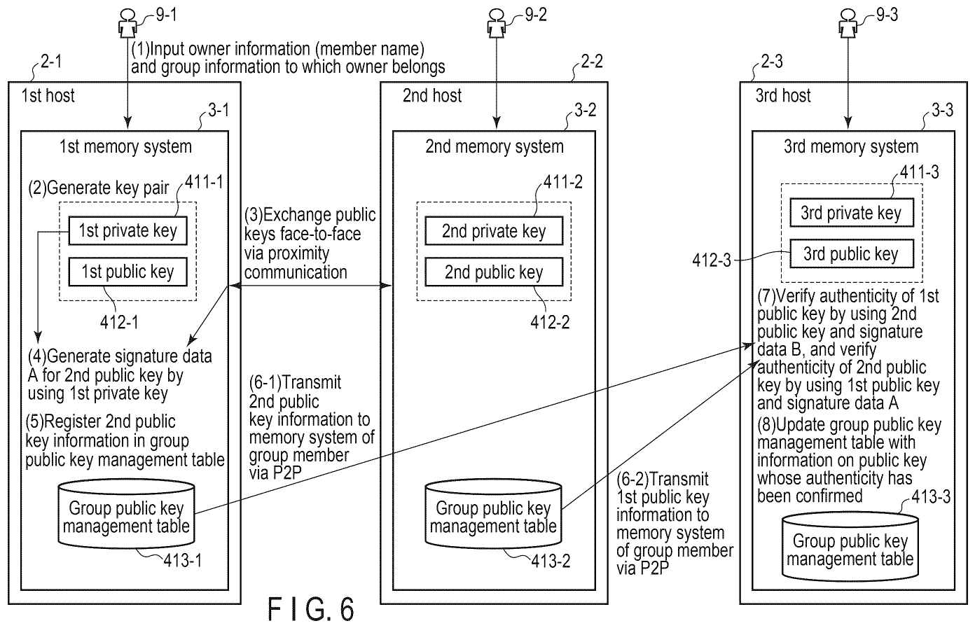

FIG. 6 illustrates an example of the public key registration operation in the information processing system 1. The public key registration operation is an operation for registering a public key 412 of a member together with signature data for the public key 412 in the group public key management table 413 in each of the memory systems 3 that are used by the members, respectively. The public key registration operation is performed, for example, in a case where public keys 412 are exchanged between two adjacent memory systems 3.

Here, the public key registration operation in the first memory system 3-1, the second memory system 3-2, and the third memory system 3-3 will be explained as an example. It is assumed that the first memory system 3-1 and the second memory system 3-2 are located within a range in which the proximity communication is executable.

The first memory system 3-1 is used by a first member 9-1. The first memory system 3-1 is, for example, included in the first host (first terminal) 2-1. The first memory system 3-1 may be provided outside the first host 2-1 and connected to the first host 2-1. The first memory system 3-1 manages a group public key management table 413-1.

The second memory system 3-2 is used by a second member 9-2. The second memory system 3-2 is, for example, included in the second host (second terminal) 2-2. The second memory system 3-2 may be provided outside the second host 2-2 and connected to the second host 2-2. The second memory system 3-2 manages a group public key management table 413-2.

The third memory system 3-3 is used by a third member 9-3. The third memory system 3-3 is, for example, included in the third host (third terminal) 2-3. The third memory system 3-3 may be provided outside the third host 2-3 and connected to the third host 2-3. The third memory system 3-3 manages a group public key management table 413-3.

Note that the first member 9-1, the second member 9-2, and the third member 9-3 belong to the one group 7.

A specific example of the public key registration operation will be described below.

First, the first memory system 3-1 receives owner information of the first memory system 3-1 and information of the group 7 to which the first member 9-1 belongs (hereinafter, referred to as group information) that have been input to the first host 2-1 according to operations by the first member 9-1 ((1) in FIG. 6). The owner information is a member name of the first member 9-1 (hereinafter, referred to as a first member name). The group information is information by which the corresponding group is uniquely identifiable. More specifically, the first member 9-1 performs the operations of inputting the owner information and the group information by using, for example, an input device of the first host 2-1. The first memory system 3-1 receives the input owner information and group information from the first host 2-1 via the data communication I/F 11.

In response to the reception of the owner information and the group information, the first memory system 3-1 generates a key pair that includes a first private key 411-1 and a first public key 412-1 ((2) in FIG. 6). The first private key 411-1 and the first public key 412-1 are a key pair corresponding to the first member 9-1. The first memory system 3-1 may add an entry that includes the first member name and the first public key 412-1 to the group public key management table 413-1.

Operations similar to the operations (1) and (2) in FIG. 6 are also performed in the second memory system 3-2. That is, the second memory system 3-2 generates a key pair that includes a second private key 411-2 and a second public key 412-2 when owner information (second member name) and group information related to the second member 9-2 have been received from the second host 2-2. The second private key 411-2 and the second public key 412-2 are a key pair corresponding to the second member 9-2.

In addition, operations similar to the operations (1) and (2) in FIG. 6 are also performed in the third memory system 3-3. The third memory system 3-3 generates a key pair that includes a third private key 411-3 and a third public key 412-3 when owner information (third member name) and group information related to the third member 9-3 have been received from the third host 2-3. The third private key 411-3 and the third public key 412-3 are a key pair corresponding to the third member 9-3.

Next, the first memory system 3-1 and the second memory system 3-2, which are located within the range in which the proximity communication is executable, exchange the first public key 412-1 and the second public key 412-2 with the proximity communication ((3) in FIG. 6). In other words, the first member 9-1 and the second member 9-2 confirm each other's identity face-to-face, and cause the first memory system 3-1 and the second memory system 3-2 to exchange the first public key 412-1 and the second public key 412-2. More specifically, the first memory system 3-1 transmits the first member name and the first public key 412-1 to the second memory system 3-2 and receives the second member name and the second public key 412-2 from the second memory system 3-2, via the proximity communication I/F 13. In addition, the second memory system 3-2 transmits the second member name and the second public key 412-2 to the first memory system 3-1 and receives the first member name and the first public key 412-1 from the first memory system 3-1, via the proximity communication I/F 13.

The first memory system 3-1 generates signature data for the received second public key 412-2 (hereinafter, referred to as signature data A) by using the first private key 411-1 ((4) in FIG. 6). Specifically, the first memory system 3-1 calculates a hash value of the second public key 412-2 by using, for example, the specific hash function. The first memory system 3-1 encrypts the calculated hash value by using the first private key 411-1, thereby generating the signature data A.

Next, the first memory system 3-1 stores (registers) information on the second public key 412-2 (hereinafter, referred to as second public key information) in the group public key management table 413-1 in the nonvolatile memory 4 ((5) in FIG. 6). The second public key information includes, for example, the second member name, the second public key 412-2, the first member name, and the signature data A. Specifically, for example, the first memory system 3-1 adds an entry including the second public key information to the group public key management table 413-1. Note that in a case where the group public key management table 413-1 already includes an entry including the second member name and the second public key 412-2, the first memory system 3-1 adds a part of the second public key information to the entry, for example. The part of the second public key information is, for example, the first member name and the signature data A.

Hereinafter, adding an entry that includes information on a public key 412 (hereinafter, referred to as public key information) to the group public key management table 413 or adding a part of the public key information to an entry in the group public key management table 413 is also referred to as registering public key information in the group public key management table 413. The public key information includes, for example, the public key 412, a member name corresponding to the public key 412, signature data for the public key 412, and a name of a member who has generated the signature data (more specifically, a member name corresponding to a private key 411 used for the generation of the signature data). The part of the public key information is, for example, the signature data for the public key 412 and the name of the member who has generated the signature data.

Operations similar to the operations (4) and (5) in FIG. 6 are also performed in the second memory system 3-2. That is, the second memory system 3-2 generates signature data for the first public key 412-1 (hereinafter, referred to as signature data B) by using the second private key 411-2. Then, the second memory system 3-2 registers the first public key 412-1 and the signature data B in the group public key management table 413-2.

Next, the first memory system 3-1 transmits the second public key information, which has been registered in the group public key management table 413-1, to a memory system 3 used by a group member other than the second member 9-2 by the P2P communication ((6-1) in FIG. 6). Specifically, the first memory system 3-1 transmits, for example, the second public key information to a memory system 3 used by a group member other than the first member 9-1 and the second member 9-2 (i.e., in FIG. 6, the third memory system 3-3) via the P2P communication I/F 12. For example, the first memory system 3-1 may acquire in advance information for performing the P2P communication with the other memory systems 3 used by the group members.

In addition, the second memory system 3-2 transmits information on the first public key 412-1 (hereinafter, referred to as first public key information), which has been registered in the group public key management table 413-2, to a memory system 3 used by a group member other than the first member 9-1 by the P2P communication ((6-2) in FIG. 6). The first public key information includes, for example, the first member name, the first public key 412-1, the second member name, and the signature data B. Specifically, the second memory system 3-2 transmits, for example, the first public key information to a memory system 3 used by a group member other than the first member 9-1 and the second member 9-2 (i.e., in FIG. 6, the third memory system 3-3) via the P2P communication I/F 12. For example, the second memory system 3-2 may acquire in advance information for performing the P2P communication with the memory systems 3 used by the group members.

The third memory system 3-3 receives the second public key information from the first memory system 3-1 via the P2P communication I/F 12. In addition, the third memory system 3-3 receives the first public key information from the second memory system 3-2 via the P2P communication I/F 12.

The third memory system 3-3 verifies the authenticity of the first public key 412-1 and the authenticity of the second public key 412-2 by using the received first public key information and second public key information ((7) in FIG. 6). Specifically, the third memory system 3-3 verifies the authenticity of the first public key 412-1 by using the second public key 412-2 in the second public key information and the signature data B in the first public key information. In addition, the third memory system 3-3 verifies the authenticity of the second public key 412-2 by using the first public key 412-1 in the first public key information and the signature data A in the second public key information.

A method in which the third memory system 3-3 verifies the authenticity of the first public key 412-1 by using the second public key 412-2 and the signature data B will be described. The third memory system 3-3 generates a hash value by decrypting the signature data B with the second public key 412-2. The third memory system 3-3 calculates a hash value of the first public key 412-1 with the specific hash function. In a case where these two hash values match each other, the third memory system 3-3 determines that the authenticity of the first public key 412-1 has been confirmed. In a case where these two hash values are different from each other, the third memory system 3-3 determines that the authenticity of the first public key 412-1 has not been confirmed.

A method in which the third memory system 3-3 verifies the authenticity of the second public key 412-2 by using the first public key 412-1 and the signature data A will be described. The third memory system 3-3 generates a hash value by decrypting the signature data A with the first public key 412-1. The third memory system 3-3 calculates a hash value of the second public key 412-2 with the specific hash function. In a case where these two hash values match each other, the third memory system 3-3 determines that the authenticity of the second public key 412-2 has been confirmed. In a case where these two hash values are different from each other, the third memory system 3-3 determines that the authenticity of the second public key 412-2 has not been confirmed.

Here, it is assumed that the authenticity of the first public key 412-1 and the authenticity of the second public key 412-2 have been confirmed.

The third memory system 3-3 updates the group public key management table 413-3 with the information on the first public key 412-1 and the second public key 412-2 whose authenticities have been confirmed (that is, with the first public key information and the second public key information) ((8) in FIG. 6).

Specifically, the third memory system 3-3 adds (stores), for example, an entry that includes the first member name, the first public key 412-1, the second member name, and the signature data B to the group public key management table 413-3 by using the first public key information. In a case where an entry including the first member name and the first public key 412-1 already exists in the group public key management table 413-3, the third memory system 3-3 adds, for example, the second member name and the signature data B to the entry.

In addition, the third memory system 3-3 adds, for example, an entry that includes the second member name, the second public key 412-2, the first member name, and the signature data A to the group public key management table 413-3 by using the second public key information. In a case where an entry including the second member name and the second public key 412-2 already exists in the group public key management table 413-3, the third memory system 3-3 adds, for example, the first member name and the signature data A to the entry.

With the public key registration operation described above, a public key 412 of a member can be registered in the group public key management table 413 in the memory system 3 together with signature data for the public key 412.

Specifically, the first memory system 3-1 registers the second public key 412-2 of the second member 9-2 in the group public key management table 413-1 together with the signature data A of the first member 9-1 for the second public key 412-2. The second memory system 3-2 registers the first public key 412-1 of the first member 9-1 in the group public key management table 413-2 together with the signature data B of the second member 9-2 for the first public key 412-1. The first memory system 3-1 and the second memory system 3-2 exchange the first public key 412-1 and the second public key 412-2 by the proximity communication (that is, the first member 9-1 and the second member 9-2 meet each other face-to-face). Therefore, the authenticity of the second public key 412-2 can be guaranteed in the group public key management table 413-1, and the authenticity of the first public key 412-1 can be guaranteed in the group public key management table 413-2.

In addition, the third memory system 3-3 registers the first public key 412-1 of the first member 9-1 in the group public key management table 413-3 together with the signature data B used to confirm the authenticity of the first public key 412-1. The third memory system 3-3 registers the second public key 412-2 of the second member 9-2 in the group public key management table 413-3 together with the signature data A used to confirm the authenticity of the second public key 412-2. Therefore, in the group public key management table 413-3, the authenticity of the first public key 412-1 can be guaranteed by the signature data B, and the authenticity of the second public key 412-2 can be guaranteed by the signature data A.

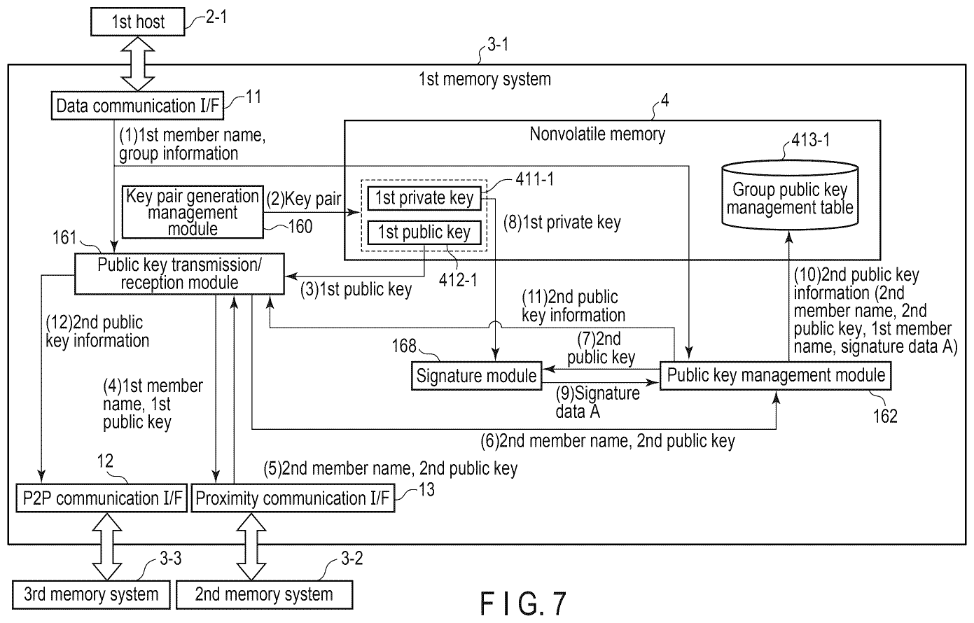

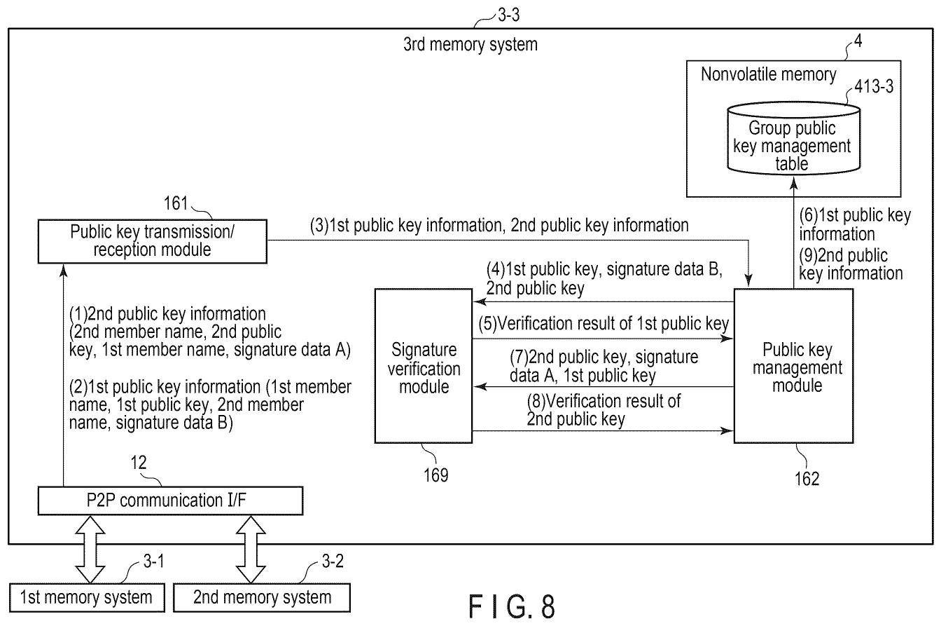

With reference to FIGS. 7 and 8, an internal operation of each memory system 3 for the public key registration operation will be described more specifically.

FIG. 7 illustrates an example of a public key exchange and registration operation in a memory system 3 in a case where public keys are exchanged with another memory system 3. Here, the public key exchange and registration operation in the first memory system 3-1 in a case where the first memory system 3-1 exchanges the public keys 412 with the second memory system 3-2 will be explained as an example. While the public keys 412 are exchanged, the first memory system 3-1 and the second memory system 3-2 are located within the range in which the proximity communication is executable. In the first memory system 3-1 illustrated in FIG. 7, the data communication I/F 11, the P2P communication I/F 12, the proximity communication I/F 13, the key pair generation management module 160, the public key transmission/reception module 161, the public key management module 162, the signature module 168, and the first private key 411-1, the first public key 412-1, and the group public key management table 413-1 in the nonvolatile memory 4 that are related to the public key exchange and registration operation are illustrated.

In the first memory system 3-1, the public key transmission/reception module 161 and the public key management module 162 receive the first member name and the group information from the host 2 via the data communication I/F 11 ((1) in FIG. 7). The first member name and the group information may be provided to other modules in the first memory system 3-1.

The key pair generation management module 160 generates the key pair that include the first private key 411-1 and the first public key 412-1, for example, in response to the reception of the first member name and the group information from the host 2 ((2) in FIG. 7). The key pair generation management module 160 stores the first private key 411-1 and the first public key 412-1 in the nonvolatile memory 4.

In a case where the first memory system 3-1 exchanges the public keys 412 with the second memory system 3-2, the public key transmission/reception module 161 reads the first public key 412-1 from the nonvolatile memory 4 ((3) in FIG. 7). Then, the public key transmission/reception module 161 transmits the first member name and the first public key 412-1 to the second memory system 3-2 via the proximity communication I/F 13 ((4) in FIG. 7). As a result, in the second memory system 3-2, the first public key 412-1 associated with the first member name is registered in the group public key management table 413-2.

In addition, the public key transmission/reception module 161 receives the second member name and the second public key 412-2 from the second memory system 3-2 via the proximity communication I/F 13 ((5) in FIG. 7). Note that the public key transmission/reception module 161 may transmit the first member name and the first public key 412-1 to the second memory system 3-2 after receiving the second member name and the second public key 412-2 from the second memory system 3-2. The public key transmission/reception module 161 sends the received second member name and second public key 412-2 to the public key management module 162 ((6) in FIG. 7).

The public key management module 162 receives the second member name and the second public key 412-2 from the public key transmission/reception module 161, and sends the second public key 412-2 to the signature module 168 ((7) in FIG. 7).

The signature module 168 reads the first private key 411-1 from the nonvolatile memory 4 in response to the reception of the second public key 412-2 from the public key management module 162 ((8) in FIG. 7). The signature module 168 generates the signature data A for the second public key 412-2 by using the first private key 411-1, and sends the signature data A to the public key management module 162 ((9) in FIG. 7).

The public key management module 162 registers the second public key information that includes the second member name, the second public key 412-2, the first member name, and the signature data A, in the group public key management table 413-1 ((10) in FIG. 7). Then, the public key management module 162 sends the second public key information to the public key transmission/reception module 161 ((11) in FIG. 7).

The public key transmission/reception module 161 transmits the second public key information received from the public key management module 162, to the third memory system 3-3 via the P2P communication I/F 12 ((12) in FIG. 7). As a result, in the third memory system 3-3, the group public key management table 413-3 is updated with the second public key information.

With the public key exchange and registration operation in the first memory system 3-1 described above, the second public key 412-2 (second public key information) is registered in the group public key management table 413-1 in the first memory system 3-1. In addition, the first public key 412-1 (first public key information) is registered in the group public key management table 413-2 in the second memory system 3-2. Further, the second public key 412-2 (second public key information) is registered in the group public key management table 413-3 in the third memory system 3-3.

Note that each of the memory systems 3 other than the first memory system 3-1 also performs a similar public key exchange and registration operation in a case where the public keys 412 are exchanged with another memory system 3.

FIG. 8 illustrates an example of a public key verification and registration operation in the memory system 3 in a case where public key information is received from each of other memory systems 3. Here, the public key verification and registration operation in the third memory system 3-3 in a case where public key information is received from each of the first memory system 3-1 and the second memory system 3-2 will be explained as an example. In the third memory system 3-3 illustrated in FIG. 8, the P2P communication I/F 12, the public key transmission/reception module 161, the public key management module 162, the signature verification module 169, and the group public key management table 413-3 in the nonvolatile memory 4 that are related to the public key verification and registration operation are illustrated.

In the third memory system 3-3, the public key transmission/reception module 161 receives the second public key information from the first memory system 3-1 via the P2P communication I/F 12 ((1) in FIG. 8). The second public key information includes the second member name, the second public key 412-2, the first member name, and the signature data A. In addition, the public key transmission/reception module 161 receives the first public key information from the second memory system 3-2 via the P2P communication I/F 12 ((2) in FIG. 8). The first public key information includes the first member name, the first public key 412-1, the second member name, and the signature data B. An order in which the public key transmission/reception module 161 receives the first public key information and the second public key information may be any order. The public key transmission/reception module 161 sends the first public key information and the second public key information to the public key management module 162 ((3) in FIG. 8).

The public key management module 162 sends the first public key 412-1 and the signature data B in the first public key information and the second public key 412-2 in the second public key information to the signature verification module 169 ((4) in FIG. 8). The signature verification module 169 verifies the authenticity of the first public key 412-1 by using the signature data B and the second public key 412-2, and sends the verification result to the public key management module 162 ((5) in FIG. 8). Then, in a case where the verification result indicates that the authenticity of the first public key 412-1 has been confirmed, the public key management module 162 registers the first public key information in the group public key management table 413-3 ((6) in FIG. 8).

In addition, the public key management module 162 sends the second public key 412-2 and the signature data A in the second public key information and the first public key 412-1 in the first public key information to the signature verification module 169 ((7) in FIG. 8). The signature verification module 169 verifies the authenticity of the second public key 412-2 by using the signature data A and the first public key 412-1, and sends the verification result to the public key management module 162 ((8) in FIG. 8). Then, in a case where the verification result indicates that the authenticity of the second public key 412-2 has been confirmed, the public key management module 162 registers the second public key information in the group public key management table 413-3 ((9) in FIG. 8).

The public key management module 162 and the signature verification module 169 may perform the operations (4), (5), and (6) after performing the operations (7), (8), and (9) in FIG. 8. Alternatively, the public key management module 162 and the signature verification module 169 may perform the operations (6) and (9) after performing the operations (4) and (5) and the operations (7) and (8) in FIG. 8.

With the public key verification and registration operation in the third memory system 3-3 described above, the information (first public key information) on the first public key 412-1 whose authenticity has been confirmed and the information (second public key information) on the second public key 412-2 whose authenticity has been confirmed can be registered in the group public key management table 413-3 in the third memory system 3-3.

Note that each of the other memory systems 3 other than the third memory system 3-3 also performs a similar public key verification and registration operation in a case where public key information is received from each of other memory systems 3 by the P2P communication.

### Content Registration Operation

In the information processing system 1, the members belonging to the group 7 share and use contents. Therefore, a content registered (stored) in a memory system 3 used by a member is also registered in the memory systems 3 used by the other members.

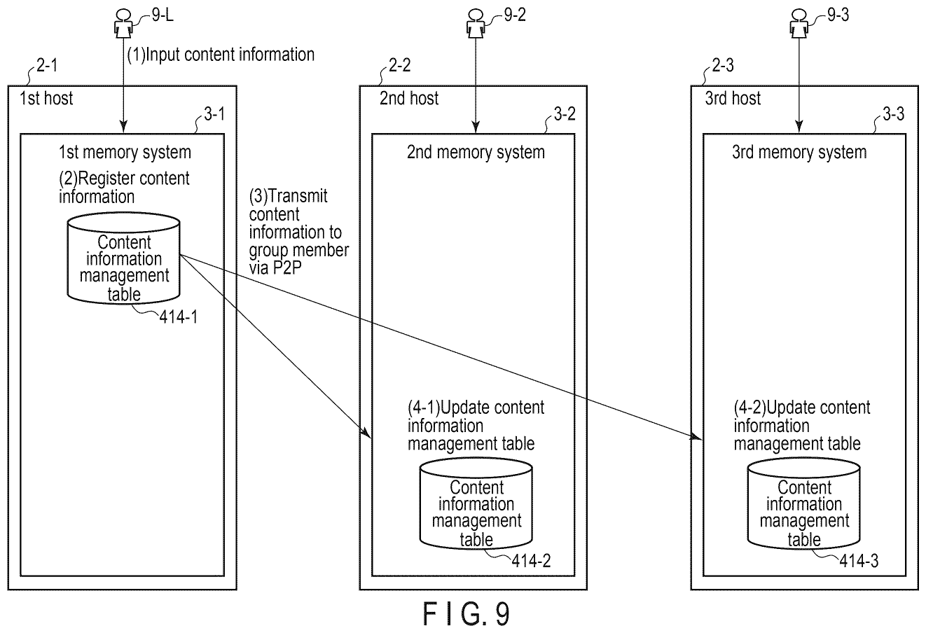

FIG. 9 illustrates an example of a content registration operation in the information processing system 1. The content registration operation is an operation of registering a content and information on the content in the content information management table 414 in each of the memory systems 3 used by the respective members.

Here, the content registration operation in the first memory system 3-1, the second memory system 3-2, and the third memory system 3-3 will be explained as an example. The first memory system 3-1 manages a content information management table 414-1. The second memory system 3-2 manages a content information management table 414-2. The third memory system 3-3 manages a content information management table 414-3.

A specific example of the content registration operation will be described below.

First, the first memory system 3-1 receives content information input to the first host 2-1 in response to an operation by a user 9-L ((1) in FIG. 9). The user 9-L may be the same user as the first member 9-1 or may be a different user. The content information includes, for example, a content ID, a content name, a content body, and information indicative of a use condition for a content. The information indicative of a use condition for a content indicates, for example, a limitation of the number of concurrent users for the content. Specifically, the user 9-L performs an operation of inputting the content information by using, for example, the input device provided in the first host 2-1. The first memory system 3-1 receives the input content information from the first host 2-1 via the data communication I/F 11.

The first memory system 3-1 stores (registers) the received content information in the content information management table 414-1 in the nonvolatile memory 4 ((2) in FIG. 9). That is, the first memory system 3-1 adds an entry that includes the content ID, the content name, the content body, and the use condition (for example, the limitation of the number of concurrent users) to the content information management table 414-1 on the basis of the content information.

Next, the first memory system 3-1 transmits the content information to the memory systems 3 used by the other group members by the P2P communication ((3) in FIG. 9). Specifically, the first memory system 3-1 transmits the content information to the second memory system 3-2 via the P2P communication I/F 12. In addition, the first memory system 3-1 transmits the content information to the third memory system 3-3 via the P2P communication I/F 12.

The second memory system 3-2 registers, in the content information management table 414-2, the content information received from the first memory system 3-1 ((4-1) in FIG. 9). In addition, the third memory system 3-3 registers, in the content information management table 414-3, the content information received from the first memory system 3-1 ((4-2) in FIG. 9).

With the content registration operation described above, the first memory system 3-1 can register the content information, which has been input from the first host 2-1 to the first memory system 3-1, in the content information management table 414-1 in the first memory system 3-1. Further, the first memory system 3-1 can register the same content information also in the content information management table 414-2 and the content information management table 414-3 respectively included in the second memory system 3-2 and the third memory system 3-3, which are used by the other group members.

In each of a case where content information is input from the second host 2-2 to the second memory system 3-2 and a case where content information is input from the third host 2-3 to the third memory system 3-3, the content information can be similarly registered not only in the content information management table 414 in the memory system 3 to which the content information is input but also in the content information management tables 414 in the memory systems 3 used by the other group members.

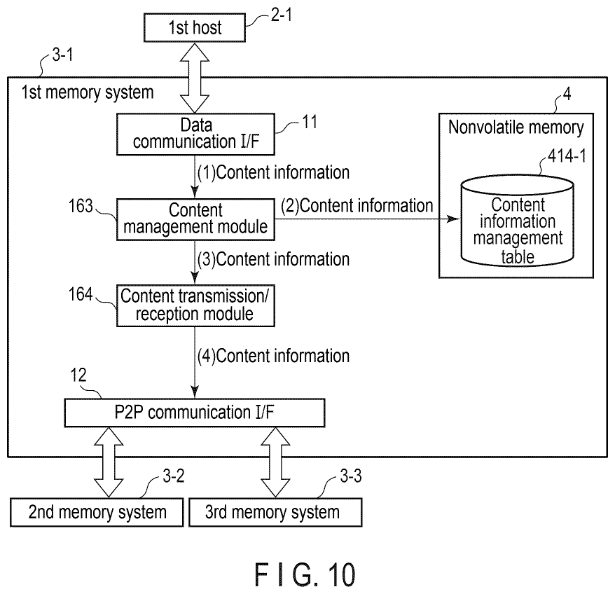

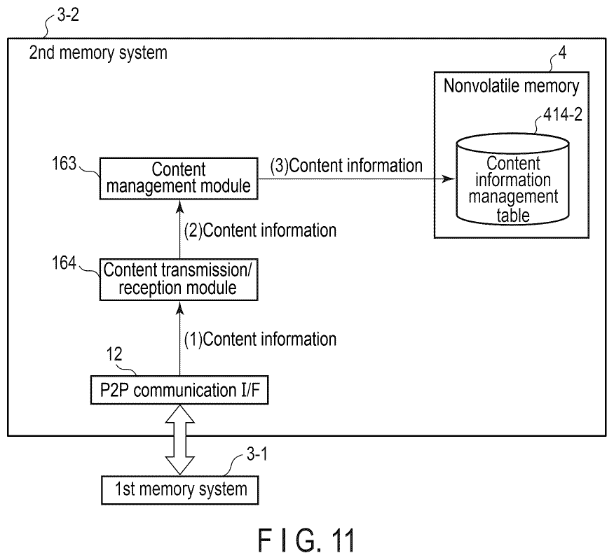

With reference to FIGS. 10 and 11, an internal operation of each memory system 3 for the content registration operation will be described more specifically.

FIG. 10 illustrates an example of a content registration and transmission operation in the memory system 3 in a case where content information is received from the host 2. Here, the content registration and transmission operation in the first memory system 3-1 in a case where the content information is received from the first host 2-1 will be explained as an example. In the first memory system 3-1 illustrated in FIG. 10, the data communication I/F 11, the P2P communication I/F 12, the content management module 163, the content transmission/reception module 164, and the content information management table 414-1 in the nonvolatile memory 4 that are related to the content registration and transmission operation are illustrated.

In the first memory system 3-1, the content management module 163 receives the content information from the first host 2-1 via the data communication I/F 11 ((1) in FIG. 10). The content management module 163 registers the content information in the content information management table 414-1 ((2) in FIG. 10). That is, the content management module 163 adds an entry that includes a content ID, a content name, a content body, and a use condition to the content information management table 414-1. Then, the content management module 163 sends the content information to the content transmission/reception module 164 ((3) in FIG. 10).

The content transmission/reception module 164 transmits the content information received from the content management module 163, to the second memory system 3-2 and the third memory system 3-3 via the P2P communication I/F 12 ((4) in FIG. 10).

With the content registration and transmission operation in the first memory system 3-1, the content information is registered in the content information management table 414-1 in the first memory system 3-1. Further, the content information transmitted by the first memory system 3-1 is registered in the content information management table 414-2 in the second memory system 3-2 and the content information management table 414-3 in the third memory system 3-3.

Note that each of the memory systems 3 other than the first memory system 3-1 also performs a similar content registration and transmission operation in a case where content information is received from a corresponding host 2.

FIG. 11 illustrates an example of a content reception and registration operation in the memory system 3 in a case where content information is received from another memory system 3. Here, the content reception and registration operation in the second memory system 3-2 in a case where the content information is received from the first memory system 3-1 will be explained as an example. In the second memory system 3-2 illustrated in FIG. 11, the P2P communication I/F 12, the content management module 163, the content transmission/reception module 164, and the content information management table 414-2 in the nonvolatile memory 4 that are related to the content reception and registration operation are illustrated.

In the second memory system 3-2, the content transmission/reception module 164 receives the content information from the first memory system 3-1 via the P2P communication I/F 12 ((1) in FIG. 11). The content transmission/reception module 164 sends the received content information to the content management module 163 ((2) in FIG. 11).

The content management module 163 registers, in the content information management table 414-2, the content information received from the content transmission/reception module 164 ((3) in FIG. 11). That is, the content management module 163 adds an entry that includes the content ID, the content name, the content body, and the use condition to the content information management table 414-2.

With the content reception and registration operation in the second memory system 3-2 described above, the content information is registered in the content information management table 414-2 in the second memory system 3-2. Note that each of the other memory systems 3 other than the second memory system 3-2 also performs a similar content reception and registration operation in a case where content information is received from another memory system 3.

### Use Start Information Logging Operation

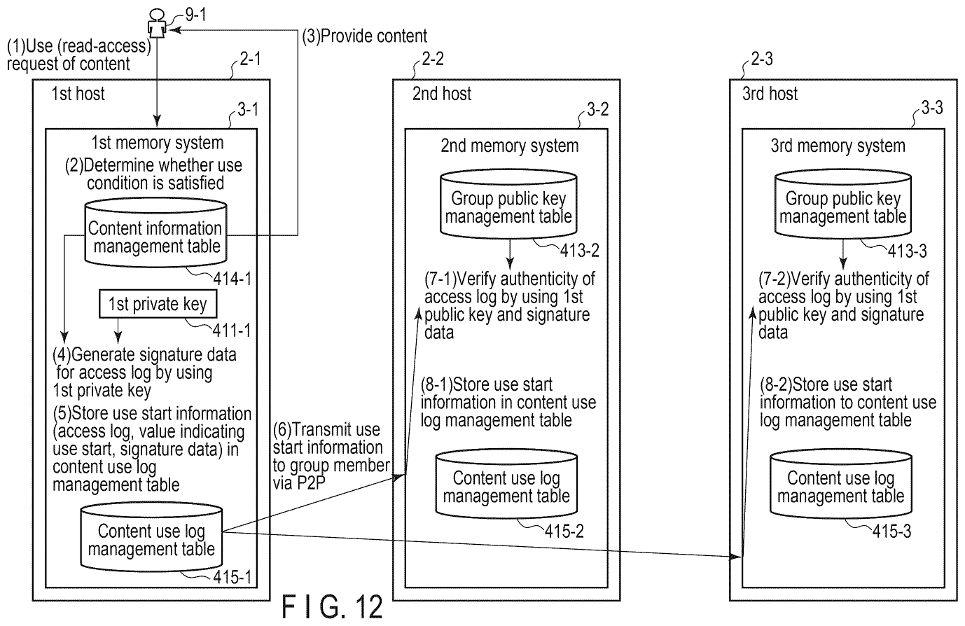

FIG. 12 illustrates an example of a use start information logging operation in the information processing system 1. The use start information logging operation is an operation for controlling use of a content by a member and logging information indicating that the use of the content by the member has been started (use start information) in the content use log management table 415 in each of the memory systems 3 used by the respective members. The use start information logging operation is performed when a member has requested the memory system 3 to use a content via the host 2. Here, the use start information logging operation in the first memory system 3-1, the second memory system 3-2, and the third memory system 3-3 will be explained as an example.

The first memory system 3-1 receives a use request for a content (target content) generated by the first host 2-1 in response to an operation by the first member 9-1 ((1) in FIG. 12). The use request for the target content is, for example, the first read access request (for example, the first read command) for reading the target content from the nonvolatile memory 4 of the first memory system 3-1. More specifically, the first member 9-1 performs an operation of requesting use of the target content by using, for example, the input device provided in the first host 2-1. The first memory system 3-1 receives the use request for the target content generated in response to the operation, from the first host 2-1 via the data communication I/F 11.

In response to the reception of the use request for the target content, the first memory system 3-1 determines whether a use condition for the target content is satisfied or not ((2) in FIG. 12). Specifically, for example, the first memory system 3-1 acquires a limitation of the number of concurrent users (concurrent user limitation) for the target content from the content information management table 414-1. The first memory system 3-1 acquires the number of members currently using the target content from the content use log management table 415-1. Then, the first memory system 3-1 determines whether or not the number of members currently using the target content is less than the limitation of the number of concurrent users.

Here, it is assumed that the number of members currently using the target content is less than the limitation of the number of concurrent users (that is, the use condition for the target content is satisfied). In this case, the first memory system 3-1 reads at least a part of the target content from the content information management table 414-1 (the nonvolatile memory 4) and transmits the read target content to the first host 2-1, thereby providing the target content to the first member 9-1 ((3) in FIG. 12). For example, the first memory system 3-1 reads the whole data of the target content from the content information management table 414-1 and transmits the read data to the first host 2-1. Alternatively, the first memory system 3-1 may sequentially read data portions of the target content from the content information management table 414-1 and sequentially transmit the data portions to the first host 2-1.

The first memory system 3-1 generates an access log related to the use of the target content by the first member 9-1, and generates signature data for the access log by using the first private key 411-1 ((4) in FIG. 12). Then, the first memory system 3-1 stores, in the content use log management table 415-1, use start information indicative of use start of the target content by the first member 9-1 ((5) in FIG. 12). The use start information includes, for example, the access log, a value indicative of use start (for example, 1), and the signature data. Specifically, the first memory system 3-1 adds an entry based on the use start information to the content use log management table 415-1 associated with the target content. Note that, for example, in a case where the content use log management table 415-1 associated with the target content already includes an entry that includes the first member name, the first memory system 3-1 updates the entry by using the use start information. Hereinafter, adding an entry based on use start information to the content use log management table 415 associated with the target content or updating an entry in the content use log management table 415 associated with the target content by using use start information is also referred to as storing use start information in the content use log management table 415.

Next, the first memory system 3-1 transmits the use start information to the other memory systems used by the group members other than the first member 9-1 by the P2P communication ((6) in FIG. 12). Specifically, the first memory system 3-1 transmits the use start information to the second memory system 3-2 via the P2P communication I/F 12. In addition, the first memory system 3-1 transmits the use start information to the third memory system 3-3 via the P2P communication I/F 12.

In response to reception of the use start information from the first memory system 3-1, the second memory system 3-2 verifies the authenticity of the access log by using the first public key 412-1 and the signature data ((7-1) in FIG. 12). Specifically, in a case where an entry (that is, the public key information) that indicates the first member 9-1 (first member name), the first public key 412-1, and the signature data for the first public key 412-1 is stored in the group public key management table 413-2 in the nonvolatile memory 4, the second memory system 3-2 acquires the first public key 412-1 corresponding to the first member 9-1 from the group public key management table 413-2 on the basis of the first member name in the access log. The second memory system 3-2 verifies the authenticity of the access log in the use start information by using the acquired first public key 412-1 and the signature data in the use start information.

Here, it is assumed that the authenticity of the access log in the use start information has been confirmed. In this case, the second memory system 3-2 stores the use start information in the content use log management table 415-2 ((8-1) in FIG. 12).

Similarly, in response to reception of the use start information from the first memory system 3-1, the third memory system 3-3 verifies the authenticity of the access log by using the first public key 412-1 and the signature data ((7-2) in FIG. 12). Specifically, the third memory system 3-3 acquires the first public key 412-1 corresponding to the first member 9-1 from the group public key management table 413-3 on the basis of the first member name in the access log. The third memory system 3-3 verifies the authenticity of the access log in the use start information by using the acquired first public key 412-1 and the signature data in the use start information.

Here, it is assumed that the authenticity of the access log included in the use start information has been confirmed. In this case, the third memory system 3-3 stores the use start information in the content use log management table 415-3 ((8-2) in FIG. 12).

With the use start information logging operation described above, in the information processing system 1, the use of the content by the member is controlled, and the use start information is stored in the content use log management tables 415 in the memory systems 3 used by the respective members. As a result, each memory system 3 can securely and easily manage use of each content by each member belonging to the group 7. Specifically, each memory system 3 can manage, for example, which member is currently using each content and the number of members currently using each content, by using the content use log management table 415.

In addition, the first memory system 3-1 stores the access log in the content use log management table 415-1 together with the signature data by which the authenticity of the access log is verifiable. Therefore, in the content use log management table 415-1, the authenticity of the access log can be guaranteed by the signature data.

Further, the second memory system 3-2 stores the access log in the content use log management table 415-2 together with the signature data that has been used to confirm the authenticity of the access log. Therefore, in the content use log management table 415-2, the authenticity of the access log can be guaranteed by the signature data. The same applies to the third memory system 3-3.

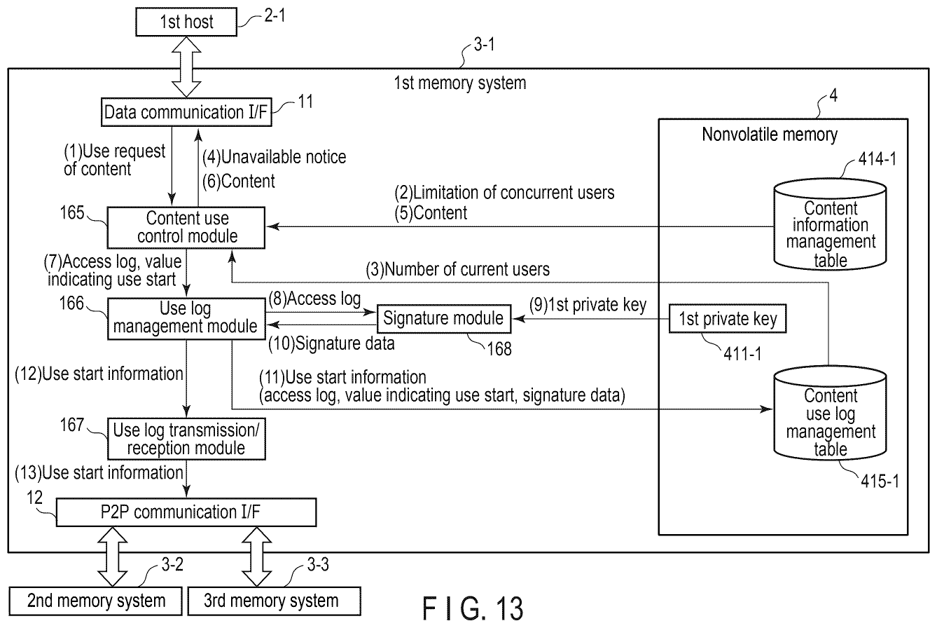

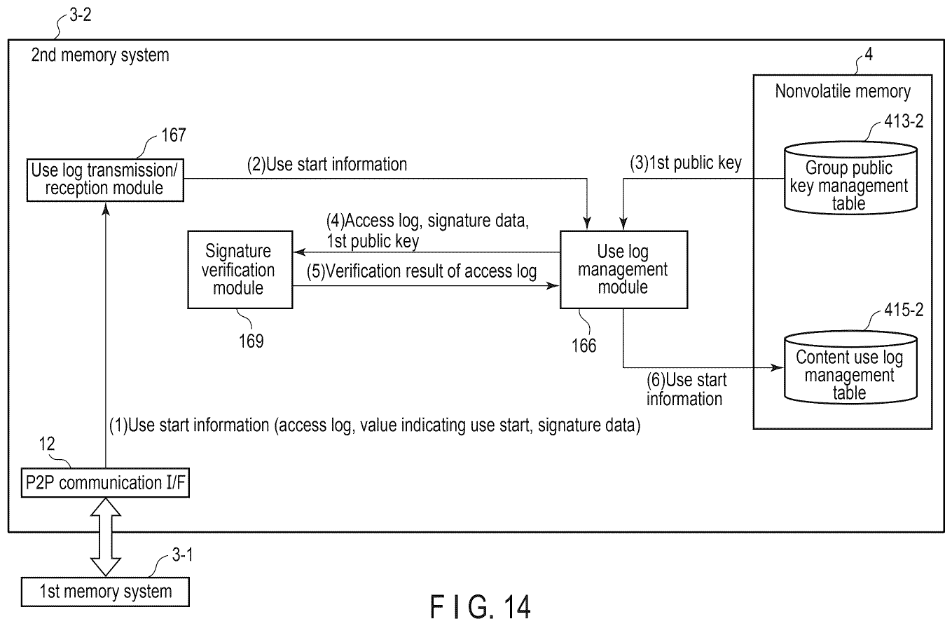

With reference to FIGS. 13 and 14, an internal operation of each memory system 3 for the use start information logging operation will be described more specifically.

FIG. 13 illustrates an example of a use control and start information logging operation in the memory system 3 in a case where use of a content is requested. Here, the use control and start information logging operation in the first memory system 3-1 in a case where use of a content (target content) is requested by the first host 2-1 will be explained as an example. In addition, it is assumed that a use condition for the target content is a limitation of the number of concurrent users. In the first memory system 3-1 illustrated in FIG. 13, the data communication I/F 11, the P2P communication I/F 12, the content use control module 165, the use log management module 166, the use log transmission/reception module 167, the signature module 168, and the first private key 411-1, the content information management table 414-1, and the content use log management table 415-1 in the nonvolatile memory 4 that are related to the use control and start information logging operation are illustrated.

In the first memory system 3-1, the content use control module 165 receives a use request for the target content from the first host 2-1 via the data communication I/F 11 ((1) in FIG. 13). In response to the reception of the use request, the content use control module 165 acquires the limitation of the number of concurrent users for the target content from the content information management table 414-1 ((2) in FIG. 13). In addition, the content use control module 165 acquires the number of users currently using the target content by using the content use log management table 415-1 ((3) in FIG. 13).

In a case where the number of users currently using the target content is equal to or more than the limitation of the number of concurrent users, the content use control module 165 notifies the first host 2-1 that the target content is unavailable via the data communication I/F 11 ((4) in FIG. 13). That is, the first member 9-1 cannot use the target content until the number of users currently using the target content falls below the limitation of the number of concurrent users.

On the other hand, in a case where the number of users currently using the target content is less than the limitation of the number of concurrent users, the content use control module 165 reads at least a part of the target content from the content information management table 414-1 ((5) in FIG. 13). The content use control module 165 transmits the read target content to the first host 2-1 via the data communication I/F 11 ((6) in FIG. 13). As a result, the first member 9-1 can use the target content. Then, the content use control module 165 generates an access log of the target content and the value indicative of use start, and sends the access log and the value to the use log management module 166 ((7) in FIG. 13).

The use log management module 166 receives the access log and the value indicative of use start from the content use control module 165, and sends the access log to the signature module 168 ((8) in FIG. 13).

In response to reception of the access log from the use log management module 166, the signature module 168 reads the first private key 411-1 from the nonvolatile memory 4 ((9) in FIG. 13). The signature module 168 generates signature data for the access log by using the first private key 411-1 and sends the signature data to the use log management module 166 ((10) in FIG. 13).

The use log management module 166 stores use start information that includes the access log, the value indicative of use start, and the signature data in the content use log management table 415-1 ((11) in FIG. 13). Then, the use log management module 166 sends the use start information to the use log transmission/reception module 167 ((12) in FIG. 13).

The use log transmission/reception module 167 transmits the use start information, which has been received from the use log management module 166, to the second memory system 3-2 and the third memory system 3-3 via the P2P communication I/F 12 ((13) in FIG. 13). As a result, in the second memory system 3-2, the use start information is stored in the content use log management table 415-2. In the third memory system 3-3, the use start information is stored in the content use log management table 415-3.

With the use control and start information logging operation in the first memory system 3-1, the use of the target content by the first member 9-1 is controlled. In a case where the target content is used, the use start information is stored in the content use log management table 415-1 in the first memory system 3-1. The use start information is also stored in the content use log management table 415-2 in the second memory system 3-2 and the content use log management table 415-3 in the third memory system 3-3.

Note that each of the other memory systems 3 other than the first memory system 3-1 performs a similar use control and start information logging operation in a case where use of a content is requested by a corresponding host 2.

FIG. 14 illustrates an example of a start information reception and logging operation in the memory system 3 in a case where use start information is received from another memory system 3. Here, the start information reception and logging operation in the second memory system 3-2 in a case where use start information is received from the first memory system 3-1 will be explained as an example. In the second memory system 3-2 illustrated in FIG. 14, the P2P communication I/F 12, the use log management module 166, the use log transmission/reception module 167, the signature verification module 169, and the group public key management table 413-2 and the content use log management table 415-2 in the nonvolatile memory 4 that are related to the start information reception and logging operation are illustrated.

In the second memory system 3-2, the use log transmission/reception module 167 receives the use start information from the first memory system 3-1 via the P2P communication I/F 12 ((1) in FIG. 14). The use start information includes the first member name, an access log, the value indicative of use start, and signature data. The use log transmission/reception module 167 sends the received use start information to the use log management module 166 ((2) in FIG. 14).

In response to reception of the use start information, the use log management module 166 acquires the first public key 412-1 from the group public key management table 413-2 ((3) in FIG. 14). Specifically, the use log management module 166 acquires the first member name included in the access log. The use log management module 166 identifies an entry that includes the acquired first member name within the group public key management table 413-2. The use log management module 166 acquires the first public key 412-1 from the identified entry. Then, the use log management module 166 sends the acquired first public key 412-1 and the access log and the signature data that are included in the use start information to the signature verification module 169 ((4) in FIG. 14).

The signature verification module 169 verifies the authenticity of the access log by using the signature data and the first public key 412-1, and sends the verification result to the use log management module 166 ((5) in FIG. 14).

In a case where the verification result indicates that the authenticity of the access log has been confirmed, the use log management module 166 stores the use start information in the content use log management table 415-2 ((6) in FIG. 14).

With the start information reception and logging operation in the second memory system 3-2, the use start information including the access log whose authenticity has been confirmed can be stored in the content use log management table 415-2. Note that each of the other memory systems 3 other than the second memory system 3-2 also performs a similar start information reception and logging operation in a case where use start information is received from another memory system 3 by the P2P communication.

### Use Completion Information Logging Operation

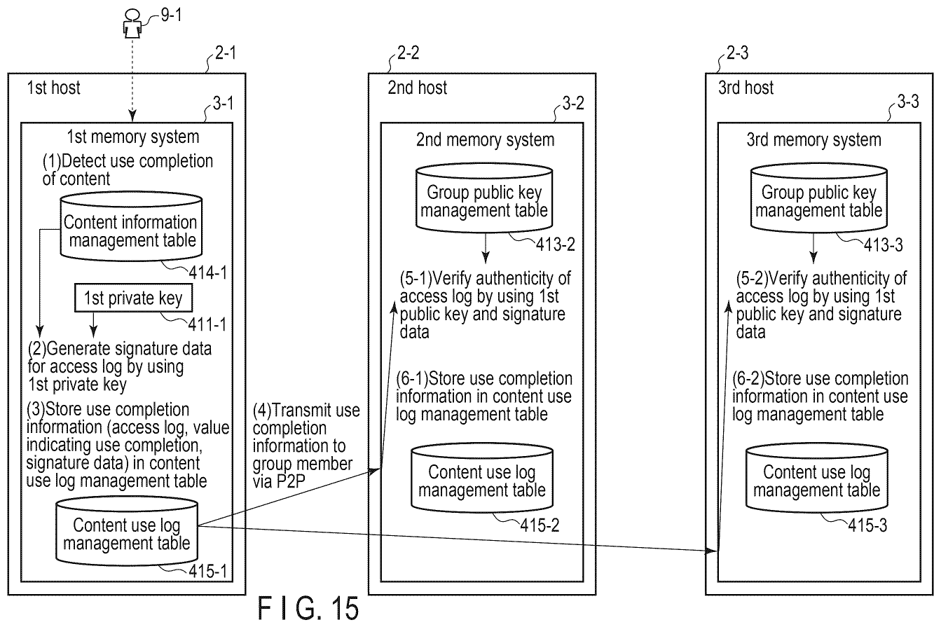

FIG. 15 illustrates an example of a use completion information logging operation in the information processing system 1. The use completion information logging operation is an operation for detecting use completion of a content (target content) by a member and storing information indicating that the use of the target content has been completed (use completion information) in the content use log management tables 415 in the memory systems 3 used by the respective members. The use completion information logging operation is performed after the use of the target content by the member (more specifically, a read access to the target content by the host 2) is started. Here, the use completion information logging operation in the first memory system 3-1, the second memory system 3-2, and the third memory system 3-3 will be explained as an example.

The first memory system 3-1 detects that the use of the target content by the first member 9-1 has been completed ((1) in FIG. 15). In response to the detection of the use completion of the target content, the first memory system 3-1 generates an access log related to the use of the target content by the first member 9-1, and generates signature data for the access log by using the first private key 411-1 ((2) in FIG. 15).

Then, the first memory system 3-1 stores use completion information indicative of the use completion of the target content by the first member 9-1 in the content use log management table 415-1 ((3) in FIG. 15). The use completion information includes, for example, the first member name, the access log, a value indicative of use completion (for example, 0), and the signature data. Specifically, the first memory system 3-1 adds an entry that includes the use completion information to the content use log management table 415-1 associated with the target content. Note that, for example, in a case where the content use log management table 415-1 associated with the target content already includes an entry including the first member name, the first memory system 3-1 updates the entry by using a part of the use completion information. The part of the use completion information is, for example, the access log, the value indicative of use completion, and the signature data. Hereinafter, adding an entry including use completion information to the content use log management table 415 associated with the target content or updating an entry in the content use log management table 415 associated with the target content by using a part of use completion information is also referred to as storing use completion information in the content use log management table 415.

Subsequent operations (4), (5-1), (6-1), (5-2), and (6-2) in FIG. 15 correspond to operations in which the use start information is replaced with the use completion information in the operations (6), (7-1), (8-1), (7-2), and (8-2) of the use start information logging operation described above with reference to FIG. 12.

With the use completion information logging operation described above, in the information processing system 1, use completion of a content by a member is detected, and use completion information is stored in the content use log management table 415 in the memory systems 3 used by the respective members. As a result, each memory system 3 can securely and easily manage use of each content by each of the members that belong to the group 7. Specifically, each memory system 3 can manage, for example, which member is currently using each content and the number of members currently using each content, by using the content use log management table 415.

In addition, the first memory system 3-1 stores the access log in the content use log management table 415-1 together with the signature data by which the authenticity of the access log is verifiable. Therefore, in the content use log management table 415-1, the authenticity of the access log can be guaranteed by the signature data.

Further, the second memory system 3-2 stores the access log in the content use log management table 415-2 together with the signature data that has been used to confirm the authenticity of the access log. Therefore, in the content use log management table 415-2, the authenticity of the access log can be guaranteed by the signature data. The same applies to the third memory system 3-3.

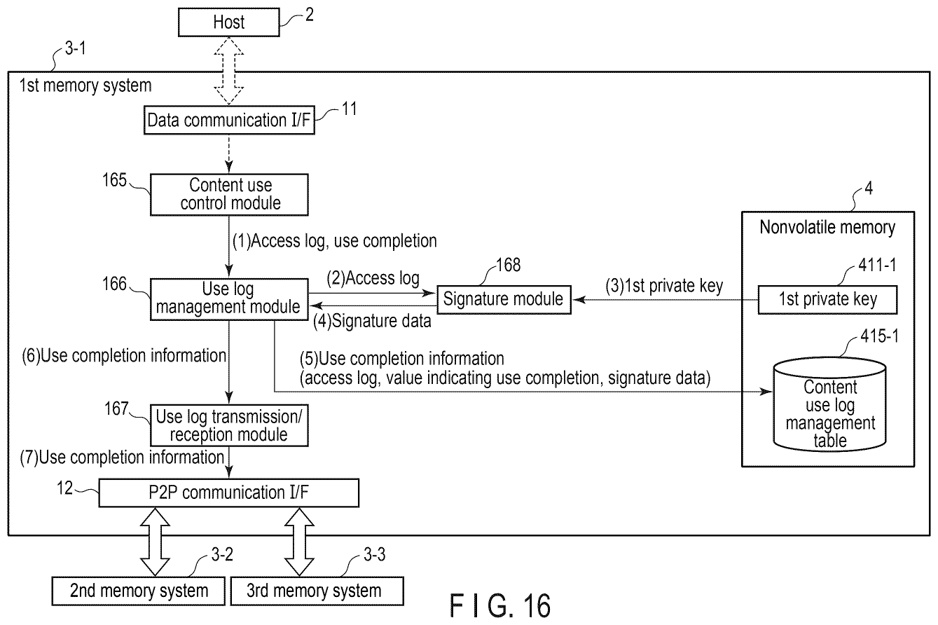

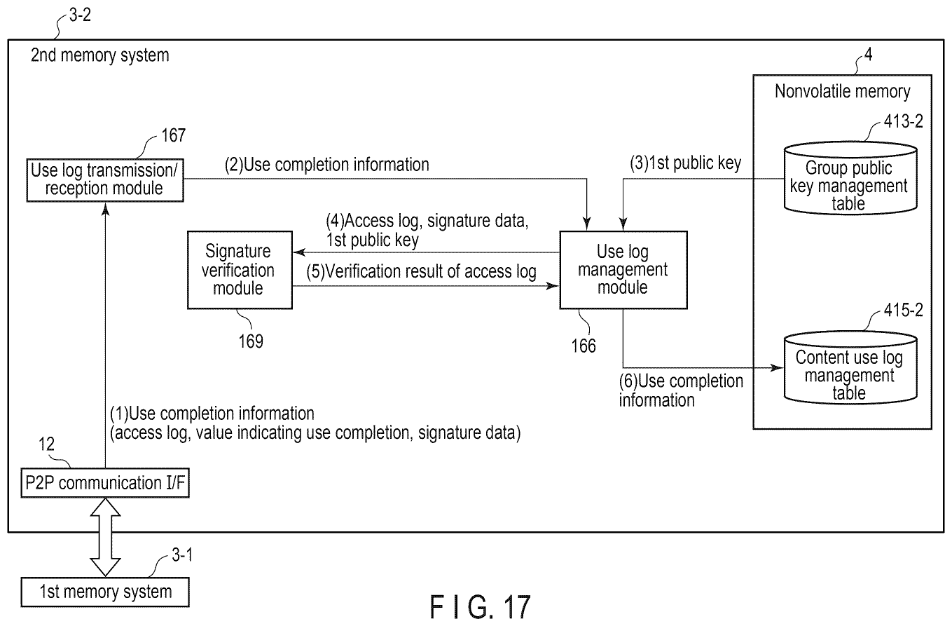

With reference to FIGS. 16 and 17, an internal operation of each memory system 3 for the use completion information logging operation will be described more specifically.

FIG. 16 illustrates an example of a completion detection and completion information logging operation in the memory system 3 in a case where an access to a content by the host 2 has been completed. Here, the completion detection and completion information logging operation in the first memory system 3-1 in a case where use completion of a content (target content) by the first host 2-1 is detected will be explained as an example. In the first memory system 3-1 illustrated in FIG. 16, the data communication I/F 11, the P2P communication I/F 12, the content use control module 165, the use log management module 166, the use log transmission/reception module 167, the signature module 168, and the first private key 411-1 and the content use log management table 415-1 in the nonvolatile memory 4 that are related to the completion detection and completion information logging operation are illustrated.

In the first memory system 3-1, when the use completion of the target content by the first host 2-1 has been detected, the content use control module 165 generates an access log of the target content and a value indicative of use completion, and sends the access log and the value to the use log management module 166 ((1) in FIG. 16).

Subsequent operations (2) to (7) in FIG. 16 correspond to operations in which the use start information is replaced with the use completion information in the operations (8) to (13) of the use control and start information logging operation described above with reference to FIG. 13.

With the completion detection and completion information logging operation in the first memory system 3-1 described above, the use completion of the target content by the first member 9-1 is detected. When the use completion of the target content has been detected, the use completion information is stored in the content use log management table 415-1 in the first memory system 3-1. The use completion information is also stored in the content use log management table 415-2 in the second memory system 3-2 and the content use log management table 415-3 in the third memory system 3-3.

Each of the other memory systems 3 other than the first memory system 3-1 performs a similar completion detection and completion information logging operation in a case where use completion of a content by a corresponding host 2 is detected.

FIG. 17 illustrates an example of a completion information reception and logging operation in the memory system 3 in a case where use completion information that indicates use completion of a content is received from another memory system 3. Here, the completion information reception and logging operation in the second memory system 3-2 in a case where the use completion information is received from the first memory system 3-1 will be explained as an example. In the second memory system 3-2 illustrated in FIG. 17, the P2P communication I/F 12, the use log transmission/reception module 167, the use log management module 166, the signature verification module 169, and the group public key management table 413-2 and the content use log management table 415-2 in the nonvolatile memory 4 that are related to the completion information reception and logging operation are illustrated.

In the second memory system 3-2, the use log transmission/reception module 167 receives the use completion information from the first memory system 3-1 via the P2P communication I/F 12 ((1) in FIG. 17). The use completion information includes the first member name, an access log, the value indicative of use completion, and signature data. The use log transmission/reception module 167 sends the received use completion information to the use log management module 166 ((2) in FIG. 17).

Subsequent operations (3) to (6) in FIG. 17 correspond to operations in which the use start information is replaced with the use completion information in the operations (3) to (6) of the start information reception and logging operation described above with reference to FIG. 14.

With the completion information reception and logging operation in the second memory system 3-2 described above, the use completion information including the access log whose authenticity has been confirmed can be stored in the content use log management table 415-2. Note that each of the other memory systems 3 other than the second memory system 3-2 also performs a similar completion information reception and logging operation in a case where use completion information is received from another memory system 3 by the P2P communication.

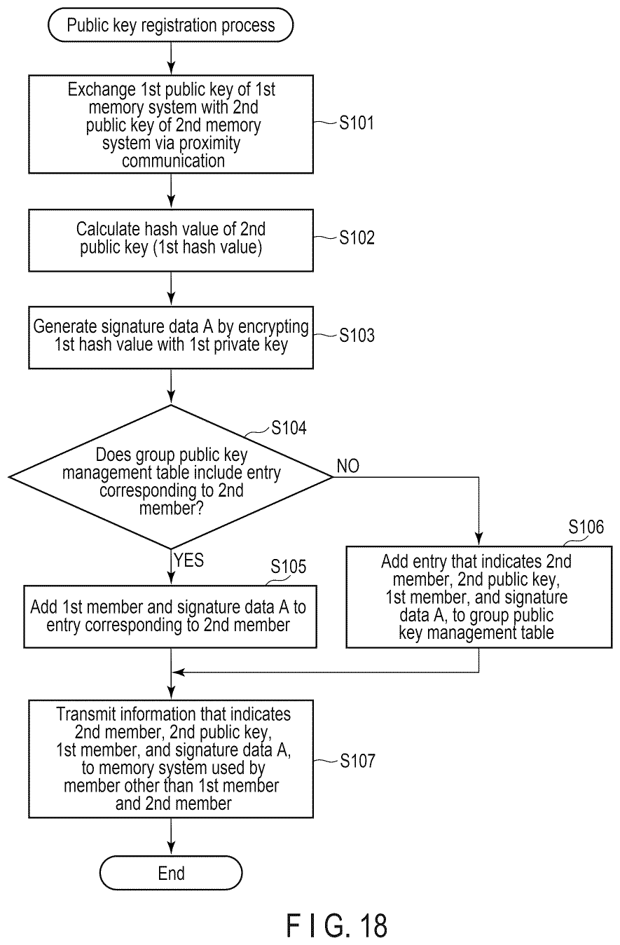

Next, the procedure of processes executed in the memory system 3 will be described with reference to flowcharts illustrated in FIGS. 18 to 22.

### Public Key Registration Process

FIG. 18 is a flowchart illustrating an example of the procedure of a public key registration process executed by the CPU 16 of the memory system 3. The public key registration process is a process for exchanging the public keys 412 with another memory system 3 by the proximity communication and registering the public key 412 obtained by the exchange in the group public key management table 413. For example, the CPU 16 executes the public key registration process when a specific operation by a member using the memory system 3 has been received. The specific operation is an operation for instructing execution of the public key registration process. The member using the memory system 3 performs the specific operation, for example, when the member wants to exchange the public keys 412 with the memory system 3 used by another member by the proximity communication.

Here, a case where the public key registration process is executed in the first memory system 3-1 will be explained as an example. In addition, it is assumed that the memory system 3 with which the first memory system 3-1 exchanges the public keys 412 is the second memory system 3-2. The first memory system 3-1 and the second memory system 3-2 are located within the range in which the proximity communication is executable. In the first memory system 3-1, the key pair including the first private key 411-1 and the first public key 412-1 is stored in the nonvolatile memory 4. In the second memory system 3-2, the key pair including the second private key 411-2 and the second public key 412-2 is stored in the nonvolatile memory 4.

First, the CPU 16 of the first memory system 3-1 exchanges the first public key 412-1 of the first memory system 3-1 with the second public key 412-2 of the second memory system 3-2 by the proximity communication (step S101). Specifically, the CPU 16 transmits the first public key 412-1 to the second memory system 3-2 via the proximity communication I/F 13, and receives the second public key 412-2 from the second memory system 3-2.

The CPU 16 calculates a hash value of the second public key 412-2 (hereinafter, referred to as a first hash value) by using the specific hash function (step S102). The CPU 16 generates signature data A by encrypting the first hash value with the first private key 411-1 (step S103).

Next, the CPU 16 determines whether or not the group public key management table 413-1 includes an entry that corresponds to the second member 9-2 using the second memory system 3-2 (that is, an entry that includes the second member name) (step S104).

In a case where the group public key management table 413-1 includes the entry corresponding to the second member 9-2 (YES in step S104), the CPU 16 adds the first member 9-1 and the signature data A to the entry (step S105), and proceeds to step 107. Specifically, the CPU 16 identifies an x-th signature member name field and an x-th signature data field for which values have not been set yet in the entry, which corresponds to the second member 9-2. Then, the CPU 16 sets the name of the first member 9-1 (first member name) in the identified x-th signature member name field, and sets the signature data A in the x-th signature data field.

In a case where the group public key management table 413-1 includes no entry corresponding to the second member 9-2 (NO in step S104), the CPU 16 adds an entry that indicates the second member 9-2, the second public key 412-2, the first member 9-1, and the signature data A to the group public key management table 413-1 (step S106), and proceeds to step S107. Specifically, the CPU 16 adds, to the group public key management table 413-1, an entry in which the name of the second member 9-2 (second member name), the second public key 412-2, the first member name, and the signature data A are respectively set in the member name field, the public key field, the first signature member name field, and the first signature data field.

Then, the CPU 16 transmits information (second public key information) that indicates the second member 9-2, the second public key 412-2, the first member 9-1, and the signature data A to each memory system 3 (for example, the third memory system 3-3) used by each of the group members other than the first member 9-1 and the second member 9-2 via the P2P communication I/F 12 (step S107), and ends the public key registration process.

Through the public key registration process described above, the CPU 16 of the first memory system 3-1 can exchange the public keys 412 with the second memory system 3-2, and can register the second public key 412-2 obtained by the exchange in the group public key management table 413-1 together with the signature data A. In addition, the CPU 16 transmits the second public key information that indicates the second member 9-2, the second public key 412-2, the first member 9-1, and the signature data A to each memory system 3 used by each of the group members other than the first member 9-1 and the second member 9-2. The signature data A for the second public key 412-2 is signature data generated by using the first private key 411-1. Therefore, the memory system 3 that has received the second public key information can verify the authenticity of the second public key 412-2 by using the first public key 412-1 and the signature data A.

In the above description, the public key registration process in a case where the first memory system 3-1 exchanges the public keys 412 with the second memory system 3-2 by the proximity communication has been explained. However, similar public key registration process is performed also in a case where the public keys 412 are exchanged between the other two memory systems 3 by the proximity communication.

### Public Key Verification and Registration Process

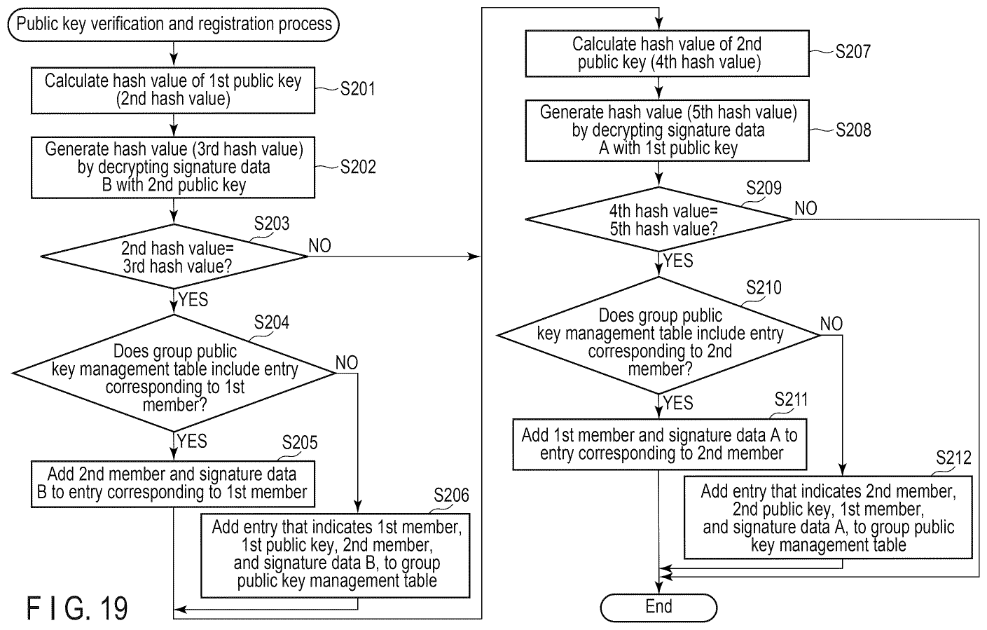

FIG. 19 is a flowchart illustrating an example of the procedure of a public key verification and registration process executed by the CPU 16 of the memory system 3. The public key verification and registration process is a process for verifying the authenticity of a public key 412 included in public key information received from another memory system 3 and registering the public key 412 whose authenticity has been confirmed in the group public key management table 413. For example, the CPU 16 executes the public key verification and registration process in response to reception of public key information from each of other two memory systems 3.

Here, a case where the public key verification and registration process is executed in the third memory system 3-3 will be explained as an example. It is assumed that the third memory system 3-3 has received public key information from each of the first memory system 3-1 and the second memory system 3-2. The public key information received from the second memory system 3-2 (first public key information) is information indicative of the first member 9-1, the first public key 412-1, the second member 9-2, and the signature data B. The signature data B is signature data for the first public key 412-1. The public key information received from the first memory system 3-1 (second public key information) is information indicative of the second member 9-2, the second public key 412-2, the first member 9-1, and the signature data A. The signature data A is signature data for the second public key 412-2.

First, the CPU 16 of the third memory system 3-3 calculates a hash value of the first public key 412-1 included in the first public key information (hereinafter, referred to as a second hash value) by using the specific hash function (step S201). The CPU 16 decrypts the signature data B by using the second public key 412-2 included in the second public key information, thereby generating a hash value (hereinafter, referred to as a third hash value) (step S202). Then, the CPU 16 determines whether or not the second hash value is equal to the third hash value (step S203). The fact that the second hash value is equal to the third hash value means that the authenticity of the first public key 412-1 has been confirmed based on the second public key 412-2 and the signature data B.

In a case where the second hash value is different from the third hash value (NO in step S203), the process by the CPU 16 proceeds to step S207. That is, since the authenticity of the first public key 412-1 has not been confirmed, the CPU 16 proceeds to a process for verifying the authenticity of the second public key 412-2 without registering the first public key information in the group public key management table 413-3.

In a case where the second hash value is equal to the third hash value (YES in step S203), the CPU 16 determines whether or not the group public key management table 413-3 includes an entry corresponding to the first member 9-1 who uses the first memory system 3-1 (that is, an entry in which the first member name is set in the member name field) (step S204).

In a case where the group public key management table 413-3 includes the entry corresponding to the first member 9-1 (YES in step S204), the CPU 16 adds the second member 9-2 and the signature data B to the entry corresponding to the first member 9-1 (step S205), and proceeds to step 207. Specifically, the CPU 16 identifies, in the entry corresponding to the first member 9-1, an x-th signature member name field and an x-th signature data field for which values have not been set yet. Then, the CPU 16 sets the name of the second member 9-2 (second member name) in the identified x-th signature member name field, and sets the signature data B in the identified x-th signature data field.

In a case where the group public key management table 413-3 includes no entry corresponding to the first member 9-1 (NO in step S204), the CPU 16 adds an entry indicative of the first member 9-1, the first public key 412-1, the second member 9-2, and the signature data B to the group public key management table 413-3 (step S206), and proceeds to step S207. Specifically, the CPU 16 adds, to the group public key management table 413-3, an entry in which the first member name, the first public key 412-1, the second member name, and the signature data B are respectively set in the member name field, the public key field, the first signature member name field, and the first signature data field.

Next, the CPU 16 calculates a hash value of the second public key 412-2 (hereinafter, referred to as a fourth hash value) by using the specific hash function (step S207). The CPU 16 decrypts the signature data A by using the first public key 412-1, thereby generating a hash value (hereinafter, referred to as a fifth hash value) (step S208). Then, the CPU 16 determines whether or not the fourth hash value is equal to the fifth hash value (step S209). The fact that the fourth hash value is equal to the fifth hash value means that the authenticity of the second public key 412-2 has been confirmed based on the first public key 412-1 and the signature data A.

In a case where the fourth hash value is different from the fifth hash value (NO in step S209), the CPU 16 ends the public key verification and registration process. That is, since the authenticity of the second public key 412-2 has not been confirmed, the CPU 16 ends the public key verification and registration process without registering the second public key information in the group public key management table 413-3.

In a case where the fourth hash value is equal to the fifth hash value (YES in step S209), the CPU 16 determines whether or not the group public key management table 413-3 includes an entry corresponding to the second member 9-2 who uses the second memory system 3-2 (that is, an entry in which the second member name is set in the member name field) (step S210).

In a case where the group public key management table 413-3 includes the entry corresponding to the second member 9-2 (YES in step S210), the CPU 16 adds the first member 9-1 and the signature data A to the entry corresponding to the second member 9-2 (step S211), and ends the public key verification and registration process.

In a case where the group public key management table 413-1 includes no entry corresponding to the second member 9-2 (NO in step S210), the CPU 16 adds an entry indicative of the second member 9-2, the second public key 412-2, the first member 9-1, and the signature data A to the group public key management table 413-3 (step S212), and ends the public key verification and registration process.

With the public key verification and registration process described above, the CPU 16 of the third memory system 3-3 can verify the authenticity of each of the first public key 412-1 and the second public key 412-2 by using the first public key information received from the second memory system 3-2 and the second public key information received from the first memory system 3-1. Then, the CPU 16 can register, in the group public key management table 413-3, information on the first public key 412-1 and the second public key 412-2 whose authenticities have been confirmed.

The CPU 16 may execute the process from step S207 to step S212 related to the verification and registration of the second public key 412-2, and then execute the process from step S201 to step S206 related to the verification and registration of the first public key 412-1. Alternatively, the CPU 16 may execute the process from step S201 to step S206 related to the verification and registration of the first public key 412-1 and the process from step S207 to step S212 related to the verification and registration of the second public key 412-2 in parallel.

In the above description, the public key verification and registration process in a case where the third memory system 3-3 receives the public key information from each of the first memory system 3-1 and the second memory system 3-2 has been explained as an example. Furthermore, similar public key verification and registration process is also executed in a case where a memory system 3 receives public key information from each of other two memory systems 3.

### Use Control and Start Information Logging Process

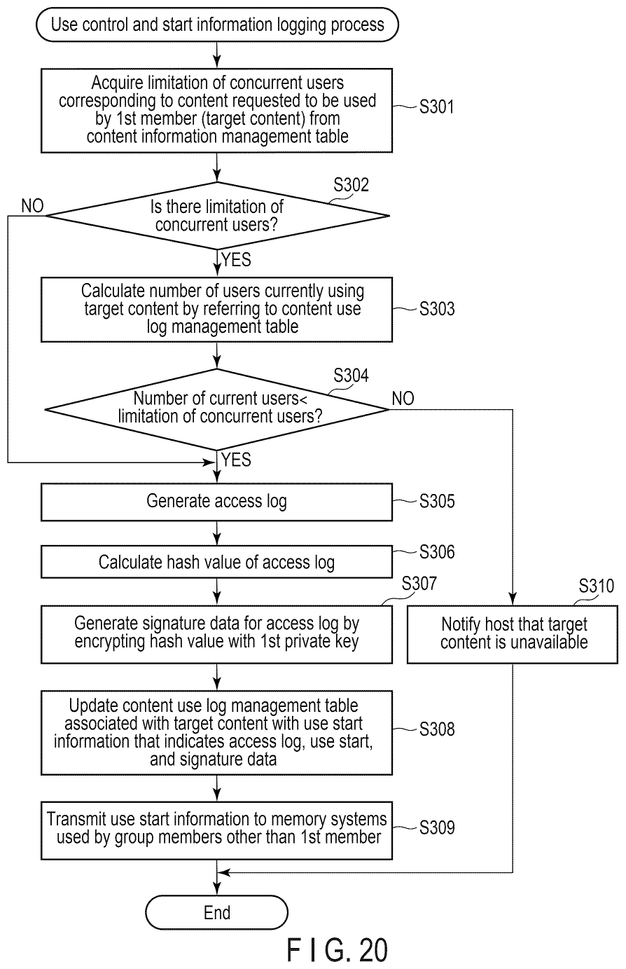

FIG. 20 is a flowchart illustrating an example of the procedure of a use control and start information logging process executed by the CPU 16 of the memory system 3. The use control and start information logging process is a process for controlling an access to a content by a member and registering a use start information indicative of start of the access to the content in the content use log management table 415. For example, the CPU 16 executes the use control and start information logging process in response to a request for an access to a content by a member.

Here, a case where the use control and start information logging process is executed in the first memory system 3-1 will be explained as an example. In this case, for example, an access to a content by the first member 9-1 is requested by the host 2 via the data communication I/F 11.

First, the CPU 16 of the first memory system 3-1 acquires a limitation of concurrent users corresponding to a content requested to be used (target content) by the first member 9-1 from the content information management table 414-1 (step S301). Specifically, for example, the CPU 16 identifies, in the content information management table 414-1, an entry including a content ID of the target content. Then, the CPU 16 acquires a value set in the concurrent user limitation field of the identified entry as the limitation of concurrent users corresponding to the target content.

The CPU 16 determines whether or not there is a limitation of concurrent users for the use of the target content (step S302). Specifically, for example, the CPU 16 determines whether or not the acquired value of the limitation of concurrent users is larger than zero. In a case where the value of the limitation of concurrent users is zero, the CPU 16 determines that there is no limitation of concurrent users for the use of the target content. In a case where the value of the limitation of concurrent users is larger than zero, the CPU 16 determines that there is a limitation of concurrent users for the use of the target content.

In a case where there is no limitation of concurrent users for the use of the target content (NO in step S302), the process by the CPU 16 proceeds to step S305.

In a case where there is a limitation of concurrent users for the use of the target content (YES in step S302), the CPU 16 calculates the number of users (members) currently using the target content by referring to the content use log management table 415-1 (step S303). Specifically, for example, the CPU 16 identifies the content use log management table 415-1 associated with the content ID of the target content among the one or more content use log management tables 415A, 415B, . . . , and 415M that respectively correspond to the one or more contents stored in the nonvolatile memory 4. The CPU 16 counts the number of entries each including the use state field in which a value indicative of use start (for example, 1) is set, among all the entries included in the identified content use log management table 415-1. As a result, the CPU 16 acquires the number of users currently using the target content.

Next, the CPU 16 determines whether or not the number of users currently using the target content is less than the limitation of concurrent users corresponding to the target content (step S304). The determination in step S304 is not limited to a condition that the number of users currently using the target content is less than the limitation of concurrent users, and any condition for determining whether or not the target content is available may be used.

In a case where the number of users currently using the target content is less than the limitation of concurrent users corresponding to the target content (YES in step S304), the process by the CPU 16 proceeds to step S305.

In step S305, the CPU 16 generates an access log indicating that the access to the target content by the first member 9-1 has been started. The generated access log includes, for example, a date and time when the access has been started, the member name of the first member 9-1, and the content ID of the target content.

The CPU 16 calculates a hash value of the generated access log by using the specific hash function (step S306). The CPU 16 generates signature data for the access log by encrypting the calculated hash value with the first private key 411-1 (step S307).

Next, the CPU 16 updates the content use log management table 415-1 associated with the target content by using use start information indicative of the access log, use start, and the signature data (step S308). Specifically, for example, the CPU 16 identifies, in the content use log management table 415-1 associated with the target content (for example, the content ID of the target content), an entry including the member name of the first member 9-1. Then, the CPU 16 sets the access log, the value indicative of use start (for example, 1), and the signature data in the access log field, the use state field, and the signature data field in the identified entry, respectively.

The CPU 16 transmits the use start information to the memory system 3 that is used by each group member other than the first member 9-1 via the P2P communication I/F 12 (step S309), and ends the use control and start information logging process.

In a case where the number of users currently using the target content is equal to or more than the limitation of concurrent users corresponding to the target content (NO in step S304), the CPU 16 notifies the host 2-1 that the target content is unavailable (step S310), and ends the use control and start information logging process.

With the use control and start information logging process described above, the CPU 16 of the first memory system 3-1 can control the access to the target content by the first member 9-1 according to whether or not the specific condition (for example, the condition of being less than the limitation of concurrent users) is satisfied. In a case where the specific condition is satisfied, the CPU 16 can register the use start information indicating that the access to the target content has been started in the content use log management table 415-1.

Further, the CPU 16 transmits the use start information to the memory system 3 that is used by each group member other than the first member 9-1. The use start information includes the access log and the signature data for the access log generated with the first private key 411-1. Therefore, the memory system 3 that has received the use start information can verify the authenticity of the access log by using the first public key 412-1 and the signature data.

In the above description, the use control and start information logging process in a case where the access to the content is requested to the first memory system 3-1 has been explained as an example. Furthermore, similar use control and start information logging process is also executed in a case where an access to a content is requested to each of the other memory systems 3.

### Completion Information Logging Process

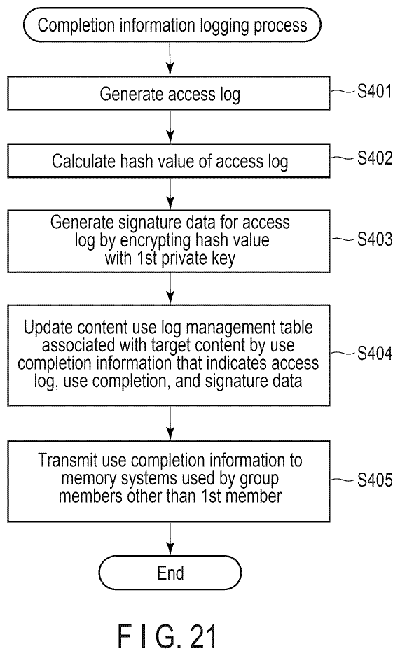

FIG. 21 is a flowchart illustrating an example of the procedure of a completion information logging process executed by the CPU 16 of the memory system 3. The completion information logging process is a process for registering use completion information indicating that use of a content by a member has been completed (finished) in the content use log management table 415. For example, the CPU 16 executes the completion information logging process in response to use completion of a content by a member.

Here, a case where the completion information logging process is executed in the first memory system 3-1 will be explained as an example. In this case, the CPU 16 of the first memory system 3-1 executes the completion information logging process when an access to a content (target content) by the first member 9-1 has been completed.

First, the CPU 16 generates an access log indicating that the access to the target content by the first member 9-1 has been completed (step S401). The generated access log includes, for example, the date and time when the access has been completed, the member name of the first member 9-1, and the content ID of the target content.

The CPU 16 calculates a hash value of the generated access log by using the specific hash function (step S402). The CPU 16 generates signature data for the access log by encrypting the calculated hash value with the first private key 411-1 (step S403).

Next, the CPU 16 updates the content use log management table 415-1 associated with the target content by using use completion information indicative of the access log, use completion, and the signature data (step S404). Specifically, for example, the CPU 16 identifies, in the content use log management table 415-1 associated with the target content, an entry including the member name of the first member 9-1. Then, the CPU 16 sets the access log, a value indicative of use completion (for example, 0), and the signature data in the access log field, the use state field, and the signature data field in the identified entry, respectively.

The CPU 16 transmits the use completion information to a memory system 3 that is used by each group member other than the first member 9-1 via the P2P communication I/F 12 (step S405), and ends the completion information logging process.

With the completion information logging process described above, the CPU 16 of the first memory system 3-1 can register the use completion information indicating that the access to the content has been completed in the content use log management table 415-1.

Further, the CPU 16 transmits the use completion information to the memory system 3 that is used by each group member other than the first member 9-1. The use completion information includes the access log and the signature data for the access log generated with the first private key 411-1. Therefore, the memory system 3 that has received the use completion information can verify the authenticity of the access log by using the first public key 412-1 and the signature data.

In the above description, the use control and start information logging process in a case where the access to the content has been completed in the first memory system 3-1 has been explained as an example. Furthermore, similar completion information logging process is also executed in a case where an access to a content has been completed in each of the other memory systems 3.

### Use Log Verification and Registration Process

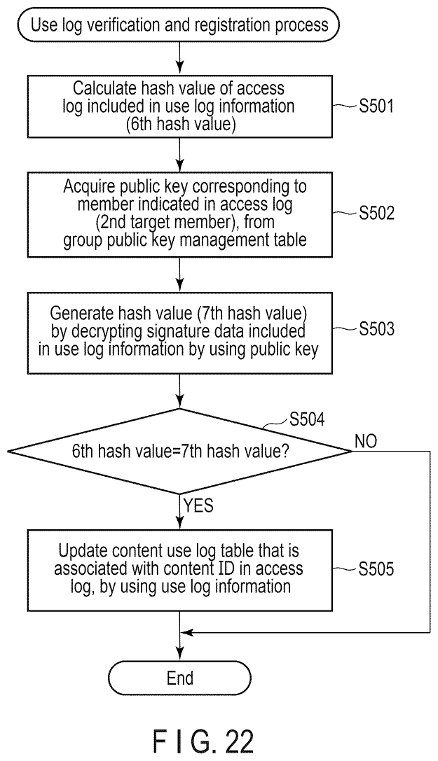

FIG. 22 is a flowchart illustrating an example of the procedure of a use log verification and registration process executed by the CPU 16 of the memory system 3. The use log verification and registration process is a process for verifying the authenticity of an access log included in use log information received from another memory system 3 and registering the access log whose authenticity has been confirmed in the content use log management table 415. The use log information is either use start information indicating that an access to a content has been started or use completion information indicating that an access to a content has been completed. The use log information includes an access log, a value indicative of use start or use completion, and signature data for the access log. For example, the CPU 16 executes the use log verification and registration process when the use log information has been received from another memory system 3.

Here, a case where the second memory system 3-2 has received the use log information from another memory system 3 will be explained as an example.

First, the CPU 16 of the second memory system 3-2 calculates a hash value of an access log included in the use log information (hereinafter, referred to as a sixth hash value) by using the specific hash function (step S501). The CPU 16 acquires, from the group public key management table 413-2, the public key 412 corresponding to a member based on a member name in the access log (hereinafter, referred to as a second target member) (step S502). The CPU 16 generate a hash value (hereinafter, referred to as a seventh hash value) by decrypting signature data included in the use log information by using the acquired public key 412 (step S503). Then, the CPU 16 determines whether or not the sixth hash value is equal to the seventh hash value (step S504). The fact that the sixth hash value is equal to the seventh hash value means that the authenticity of the access log has been confirmed.

In a case where the sixth hash value is different from the seventh hash value (NO in step S504), the CPU 16 ends the use log verification and registration process. That is, since the authenticity of the access log has not been confirmed, the CPU 16 ends the use log verification and registration process without registering the use log information in the content use log management table 415-2.

In a case where the sixth hash value is equal to the seventh hash value (YES in Step S504), the CPU 16 updates the content use log management table 415-2 that is associated with the content ID in the access log by using the use log information (Step S505), and ends the use log verification and registration process. Specifically, for example, the CPU 16 identifies the content use log management table 415-2 that is associated with the content ID in the access log among the one or more content use log management tables 415A, 415B, . . . , and 415M that respectively correspond to the one or more contents stored in the nonvolatile memory 4. In the identified content use log management table 415-2, the CPU 16 identifies an entry including the member name of the second target member. Then, the CPU 16 sets the access log, the value indicative of use start or use completion, and the signature data, which are included in the use log information, in the access log field, the use state field, and the signature data field in the identified entry, respectively.

With the use log verification and registration process described above, the CPU 16 of the second memory system 3-2 verifies the authenticity of the access log in the use log information received from the other memory system 3. Then, the CPU 16 registers the use log information including the access log whose authenticity has been confirmed in the content use log management table 415-2. That is, the CPU 16 can update the content use log management table 415-2 with the use log information including the access log whose authenticity has been confirmed.

In the above description, the use log verification and registration process in a case where the second memory system 3-2 has received the use log information from the other memory system 3 has been explained as an example. Furthermore, similar use log verification and registration process is also executed in a case where each of the other memory systems 3 has received use log information from another memory system 3.

As described above, according to the present embodiment, use of a content by each of members that belong to a group can be easily managed. The memory system 3 is used by a first user that belongs to the group 7. The controller 6 (for example, the P2P communication I/F 12 or the proximity communication I/F 13) is configured to communicate with one or more other memory systems 3 that are respectively used by one or more users other than the first user that belong to the group 7. The key pair generation management module 160 manages a first key pair including a first private key 411 and a first public key 412. The content management module 163 stores one or more pieces of content information that includes one or more contents, respectively, in the nonvolatile memory 4. In a case where use of a first content among the one or more contents by the first user is requested, the content use control module 165 generates a first access log related to the use. The use log management module 166 and the signature module 168 generate first signature data for the first access log by using the first private key 411. The use log management module 166 stores the first access log and the first signature data in the nonvolatile memory 4 (for example, the content use log management table 415). The use log transmission/reception module 167 transmits the first access log and the first signature data to the one or more other memory systems 3.

As a result, in each of the one or more other memory systems 3, the first access log and the first signature data are stored in the nonvolatile memory 4. That is, in the memory systems 3 that are respectively used by members belonging to the group 7, the first access log is shared together with the first signature data. Therefore, each memory system 3 can easily manage use of each content by each member belonging to the group 7.

In addition, each memory system 3 can verify the authenticity of the first access log by using the first signature data. Therefore, each memory system 3 can securely manage use of each content by each member belonging to the group 7 by using the access log whose authenticity has been confirmed (that is, the access log having high reliability).

Each of the various functions described in the embodiment may be realized by a circuit (e.g., processing circuit). An exemplary processing circuit may be a programmed processor such as a central processing unit (CPU). The processor executes computer programs (instructions) stored in a memory thereby performs the described functions. The processor may be a microprocessor including an electric circuit. An exemplary processing circuit may be a digital signal processor (DSP), an application specific integrated circuit (ASIC), a microcontroller, a controller, or other electric circuit components. The components other than the CPU described according to the embodiment may be realized in a processing circuit.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system used by a first user that belongs to a group, the memory system comprising:
a nonvolatile memory; and
a controller electrically connected to the nonvolatile memory and configured to communicate with one or more other memory systems that are respectively used by one or more users other than the first user, the one or more users belonging to the group, wherein
the controller is configured to:
manage a first key pair that includes a first private key and a first public key;
store, in the nonvolatile memory, one or more pieces of content information that include one or more contents, respectively;
when use of a first content among the one or more contents by the first user has been requested, generate a first access log related to the use;
generate first signature data for the first access log by using the first private key;
store the first access log and the first signature data in the nonvolatile memory; and
transmit the first access log and the first signature data to the one or more other memory systems.

2. The memory system according to claim 1, wherein
the one or more pieces of content information include first content information,
the first content information includes the first content and information that indicates a first condition under which the first content is available, and
the controller is configured to, when the use has been requested and the first condition is satisfied:
generate the first access log;
generate the first signature data;
store the first access log and the first signature data in the nonvolatile memory; and
transmit the first access log and the first signature data to the one or more other memory systems.

3. The memory system according to claim 1, wherein
the one or more other memory systems include a second memory system,
the second memory system
is used by a second user among the one or more users and
manages a second key pair that includes a second private key and a second public key, and
the controller is further configured to:
transmit the first public key to the second memory system and receive the second public key from the second memory system;
generate second signature data for the second public key by using the first private key; and
transmit second public key information that indicates the second user, the second public key, the first user, and the second signature data, to the one or more other memory systems other than the second memory system.

4. The memory system according to claim 3, wherein
the controller is further configured to store the second public key information in the nonvolatile memory.

5. The memory system according to claim 3, wherein
the controller is configured to:
via a first interface circuit that performs proximity communication, transmit the first public key to the second memory system and receive the second public key from the second memory system; and
via a second interface circuit, transmit the second public key information to the one or more other memory systems other than the second memory system.

6. The memory system according to claim 3, wherein
the controller is further configured to:
receive second content information that includes a second content from a host;
store the second content information in the nonvolatile memory; and
transmit the second content information to the one or more other memory systems.

7. The memory system according to claim 6, wherein
the controller is configured to:
via a first interface circuit that performs proximity communication, transmit the first public key to the second memory system and receive the second public key from the second memory system; and
via a second interface circuit, transmit the second public key information to the one or more other memory systems other than the second memory system.

8. The memory system according to claim 7, wherein
the controller is configured to transmit the first access log and the first signature data to the one or more other memory systems via the second interface circuit.

9. The memory system according to claim 8, wherein
the controller is configured to:
receive the second content information from the host via a third interface circuit; and
transmit the second content information to the one or more other memory systems via the second interface circuit.

10. A memory system used by a first user that belongs to a group, the memory system comprising:
a nonvolatile memory;
a controller electrically connected to the nonvolatile memory and configured to communicate with one or more other memory systems that are respectively used by one or more users other than the first user, the one or more users belonging to the group, wherein
the one or more other memory systems include a second memory system,
the second memory system is used by a second user among the one or more users, and
the controller is configured to:
manage a first key pair that includes a first private key and a first public key;
store, in the nonvolatile memory, one or more pieces of content information that include one or more contents, respectively;
receive, from the second memory system, a first access log related to use of a first content among the one or more contents by the second user and first signature data for the first access log; and
in a case where second public key information that indicates the second user, a second public key, and second signature data for the second public key has been stored in the nonvolatile memory, verify authenticity of the first access log by using the second public key and the first signature data.

11. The memory system according to claim 10, wherein
the controller is further configured to, in a case where the authenticity of the first access log has been confirmed, store the first access log and the second signature data in the nonvolatile memory.

12. The memory system according to claim 10, wherein
the one or more other memory systems further include a third memory system,
the third memory system is used by a third user among the one or more users, and
the controller is further configured to:
receive, from the second memory system,
information that indicates the third user, a third public key, the second user, and third signature data for the third public key;
receive, from the third memory system, information that indicates the second user, the second public key, the third user, and the second signature data; and
perform at least one of verification of authenticity of the second public key that uses the third public key and the second signature data and verification of authenticity of the third public key that uses the second public key and the third signature data.

13. The memory system according to claim 12, wherein
the controller is further configured to:
in a case where the authenticity of the second public key has been confirmed, store the second public key information that indicates the second user, the second public key, the third user, and the second signature data, in the nonvolatile memory; and
in a case where the authenticity of the third public key has been confirmed, store third public key information that indicates the third user, the third public key, the second user, and the third signature data, in the nonvolatile memory.

14. The memory system according to claim 10, wherein
the controller is further configured to:
transmit the first public key to the second memory system and receive the second public key from the second memory system;
generate the second signature data for the second public key by using the first private key; and
store the second public key information that indicates the second user, the second public key, the first user, and the second signature data, in the nonvolatile memory.

15. The memory system according to claim 14, wherein
the controller is configured to:
via a first interface circuit that performs proximity communication, transmit the first public key to the second memory system and receive the second public key from the second memory system; and
via a second interface circuit, receive the first access log and the first signature data from the second memory system.

16. The memory system according to claim 14, wherein
the controller is further configured to
transmit the second public key information to the one or more other memory systems other than the second memory system.

17. The memory system according to claim 16, wherein
the controller is configured to:
via a first interface circuit that performs proximity communication, transmit the first public key to the second memory system and receive the second public key from the second memory system;
via a second interface circuit, transmit the second public key information to the one or more other memory systems other than the second memory system; and
via the second interface circuit, receive the first access log and the first signature data from the second memory system.

18. The memory system according to claim 14, wherein
the controller is further configured to:
receive second content information that includes a second content from the second memory system; and
store the second content information in the nonvolatile memory.

19. The memory system according to claim 18, wherein
the controller is configured to:
via a first interface circuit that performs proximity communication, transmit the first public key to the second memory system and receive the second public key from the second memory system; and
via a second interface circuit, receive the second content information from the second memory system.

20. An information processing system comprising memory systems that are respectively used by users that belong to a group,
the memory systems including a first memory system and a second memory system,
the first memory system being used by a first user among the users,
the second memory system being used by a second user among the users,
the first memory system being configured to:
manage a first key pair that includes a first private key and a first public key;
store one or more pieces of content information that includes one or more contents, respectively, in a nonvolatile memory of the first memory system;
in a case where use of a first content among the one or more contents by the first user has been requested, generate a first access log related to the use;
generate first signature data for the first access log by using the first private key;
store the first access log and the first signature data in the nonvolatile memory; and
transmit the first access log and the first signature data to at least the second memory system, and
the second memory system being configured to:
receive the first access log and the first signature data from the first memory system; and
in a case where first public key information that indicates the first user, the first public key, and second signature data for the first public key has been stored in a nonvolatile memory of the second memory system, verify authenticity of the first access log by using the first public key and the first signature data.
